(19) United States
(12) Patent Application Publication
(10) Pub. No.: US 2026/0093115 A1
(43) Pub. Date: Apr. 2, 2026

(54) MOTION TRACKING FOR DEVICES ON MOVING VEHICLES

(71) Applicant: Google LLC, Mountain View, CA (US)

(72) Inventors: Chao Guo, Los Altos, CA (US); Qiyue Zhang, Santa Clara, CA (US); Jiunn-Kai Huang, Mountain View, CA (US); Joshua Anthony Hernandez, Redwood City, CA (US); Mahesh Ramachandran, Dublin, CA (US); Mingsheng Yin, Sunnyvale, CA (US); Luca Ballan, San Jose, CA (US)

(21) Appl. No.: 18/902,068

(22) Filed: Sep. 30, 2024

(51) Int. Cl. G02B 27/01; G06F 3/01; G06T 7/20; G06T 7/73; G06T 19/00; G06V 20/56; G06V 20/59

(52) U.S. Cl. CPC G02B 27/0172; G06F 3/012; G06T 7/20; G06T 7/75; G06T 19/006; G06V 20/56; G06V 20/59

(57) ABSTRACT

In described techniques, a first sensor signal is received from a first sensor coupled to an extended reality device within a moving frame of reference. A second sensor signal is received from an image sensor within the moving frame of reference and in communication with the extended reality device. A motion of the extended reality device with respect to the moving frame of reference may be determined, based on the first sensor signal and the second sensor signal.

### BACKGROUND

Motion tracking, such as head motion tracking for extended reality (XR) devices, may be performed using various techniques. For example, Inertial Measurement Units (IMUs) coupled to an XR device may be used. In other examples, Visual Inertial Odometry (VIO) techniques may be used, in which, e.g., image data from an image sensor is combined with motion data from an IMU for motion tracking.

### SUMMARY

Described techniques enable motion tracking when a device being tracked is in a moving frame of reference, such as in a moving vehicle. An image sensor of one device that is within the moving frame of reference, e.g., in the moving vehicle, may be used in conjunction with another device to isolate motion being tracked from the motion of the moving frame of reference. In a first example, a camera and motion sensor of a first device may be used in conjunction with a motion sensor and/or camera of a second device that is rigidly fixed within the moving frame of reference (e.g., may be attached to a frame of a moving vehicle). In a second example, the second device may include an image sensor directed outside of a window of a moving vehicle, and captured image data may be used to subtract common motion measurements from the captured image data and from motion measurements captured by the first device. In a third example, the second device may include an image sensor that is within a vehicle in which the first device is located, but that is not rigidly fixed within the vehicle. For example, the first device and second device may communicate to construct a map of a vehicle interior, which may be used to determine motion with respect to the map/interior.

In a general aspect, a method includes receiving a first sensor signal from a first sensor coupled to an extended reality device within a moving frame of reference, receiving a second sensor signal from an image sensor within the moving frame of reference and in communication with the extended reality device, and determining a motion of the extended reality device with respect to the moving frame of reference, based on the first sensor signal and the second sensor signal.

In another general aspect, a computer program product is tangibly embodied on a non-transitory computer-readable storage medium and comprises instructions. When executed by at least one computing device (e.g., by at least one processor of the computing device), the instructions are configured to cause the at least one computing device to receive a first sensor signal from a first sensor coupled to an extended reality device within a moving frame of reference, receive a second sensor signal from an image sensor within the moving frame of reference and in communication with the extended reality device, and determine a motion of the extended reality device with respect to the moving frame of reference, based on the first sensor signal and the second sensor signal.

In another general aspect, a head-mounted device (HMD) includes at least one frame for positioning the wearable device on a body of a user, at least one display, at least one processor, and at least one memory storing instructions. When executed, the instructions cause the at least one processor receive a first sensor signal from a first sensor coupled to an extended reality device within a moving frame of reference, receive a second sensor signal from an image sensor within the moving frame of reference and in communication with the extended reality device, and determine a motion of the extended reality device with respect to the moving frame of reference, based on the first sensor signal and the second sensor signal.

The details of one or more implementations are set forth in the accompanying drawings and the description below. Other features will be apparent from the description and drawings, and from the claims.

### BRIEF DESCRIPTION OF THE DRAWINGS

FIG. 1 illustrates example implementations for motion tracking on moving vehicles.

FIG. 2 illustrates an example user interface provided using techniques associated with the implementations of FIG. 1.

FIG. 3 is a block diagram illustrating an example architecture for use in providing the example implementations of FIG. 1.

FIG. 4 is a flowchart illustrating example operations of the system of FIG. 2.

FIG. 5 is a block diagram of a state estimation system that may be used in the examples of FIGS. 1-4.

FIG. 6A is a flowchart illustrating example implementations using a device rigidly fixed to a moving vehicle.

FIG. 6B is a flowchart illustrating example implementations using a device with a camera that is rigidly fixed to a moving vehicle, with the camera facing outside of the moving vehicle.

FIG. 6C is a flowchart illustrating example implementations using two head-mounted devices.

FIG. 6D is a flowchart illustrating example implementations using a device with a camera that is rigidly fixed to a moving vehicle, with the camera facing inside of the moving vehicle.

FIG. 7 is a third person view of a user in an ambient computing environment.

FIGS. 8A and 8B illustrate front and rear views of an example implementation of a pair of smartglasses.

FIG. 9A illustrates an example implementation of a system for extended reality (XR) device controller tracking using ultrawideband (UWB) sensors.

FIG. 9B is a block diagram of an example implementation of the system of FIG. 1A.

FIG. 9C is a block diagram of another example implementation of the system of FIG. 1A.

FIG. 10 is a flowchart illustrating example operations of the systems of FIGS. 1A-1C.

FIG. 11 is a block diagram of a state estimation module that may be used in the examples of the systems of FIGS. 1A-1C.

FIG. 12 illustrates an example system for range and angle determination using UWB sensors for use in the state estimation module of FIG. 3.

FIG. 13A is a flowchart illustrating example calculations for predicting range and angle measurements using an inertial measurement unit (IMU) for use in the state estimation module of FIG. 11.

FIG. 13B is a flowchart illustrating example calculations for determining a residual function used to determine a difference between the range and angle determination of FIG. 4 and the range and angle prediction of FIG. 5A, for use in the state estimation module of FIG. 3.

FIG. 14 is a block diagram illustrating an example initialization procedure for use in the examples of FIGS. 1A-1C.

### DETAILED DESCRIPTION

Described systems and techniques enable motion tracking using a device that is in a moving frame of reference, such as within a vehicle. Moreover, when the device includes an XR device, such as a Virtual Reality (VR) device, described techniques may be used to minimize or prevent motion sickness.

Existing motion tracking systems have at least the technical problem(s) of providing inaccurate motion tracking when a motion tracking device is within a moving frame of reference. For example, a user wearing an XR device in a moving vehicle may experience inaccurate head tracking because motion sensors in the XR device intended for head tracking also detect (and respond to) movements of the vehicle. Moreover, motion sickness is a known problem associated with VR and other XR devices, and such motion sickness may be exacerbated by the additional motion of a moving vehicle.

The technical solutions described herein for the above-referenced and related technical problems provide accurate motion tracking and reduced motion sickness for a first device, using at least a second device that is within the same moving frame of reference as the first device. For example, one technical solution described includes rigidly mounting the second device to the moving frame of reference, e.g., to a moving car. Then, in some implementations, a field of view of an image sensor of the second device may be directed outside of (e.g., outside a window of a moving car). Then, captured image data from the second device may be used to reduce or eliminate motion artifacts caused by the moving frame of reference in the motion tracking of the first device.

In another technical solution, the second device includes an XR device that is within the same moving frame of reference as the first device. Then, image data from a camera of the second/XR device may be used in conjunction with a common landmark or map available to both the first device and the second/XR device to establish a common, virtual stationary (e.g., stationary for purposes of motion tracking) frame of reference. For example, such a common frame of reference may include an interior of a car.

In more specific example embodiments, techniques for performing head tracking for an XR device (e.g., a HMD) in a moving vehicle, such as a car, are described. As referenced above, head tracking techniques for XR devices may use IMUs or other sensors to determine head positions and head movements of users wearing HMDs. When a user is in a moving vehicle, such as in the backseat of a car, the motion of the car will disrupt the motion tracking of the IMUs/HMD sensors and will lead to inaccurate head tracking results. Additionally, motion sickness resulting from VR environments may be more likely when the user is riding in a vehicle.

Described techniques provide accurate head tracking and reduce motion sickness when providing head tracking for an HMD, through the use of image data received from a second, off-device camera (e.g., a camera not physically coupled to the HMD, but in wireless communication with the HMD). Image data from the off-device camera is used in conjunction with motion sensor data local to the HMD to improve accuracy of head tracking operations while the HMD is also moving in a vehicle. Motion sensor data, e.g., IMU data from an IMU attached to the off-device camera, may be used, as well.

In some implementations, the off-device camera may be mounted to the vehicle with a camera directed outside of the vehicle. For example, a smartphone may be mounted to a windshield or window of the vehicle. Such embodiments may also provide a constant frame of reference from outside of the vehicle, which may be superimposed or overlapped with a display of the HMD to reduce motion sickness.

In other implementations, the off-device camera external to a first HMD may be coupled to a second HMD that is worn by another user within the vehicle and that is in wireless communication with the first HMD. Then, first image data received from a first camera of the first HMD may be combined with second image data received from a second camera of the second HMD, e.g., to determine common landmarks within both sets of image data and thereby determine a common frame of reference or a shared map.

In described implementations, dynamic motion of the vehicle (e.g., acceleration and angular velocity) may thus be estimated and removed from IMU measurements obtained at the first/primary HMD, while taking into account bias and noise from the various motion sensors being used. Put another way, motion signal portions that are common to both sources of measurement may be extracted to leave only the calibrated signal portion of the first HMD itself, which may thus be used for accurate head gaze tracking. In other words, the HMD is provided with a virtual dynamic measurement that characterizes the motion of the HMD with respect to the vehicle, or other moving frame of reference.

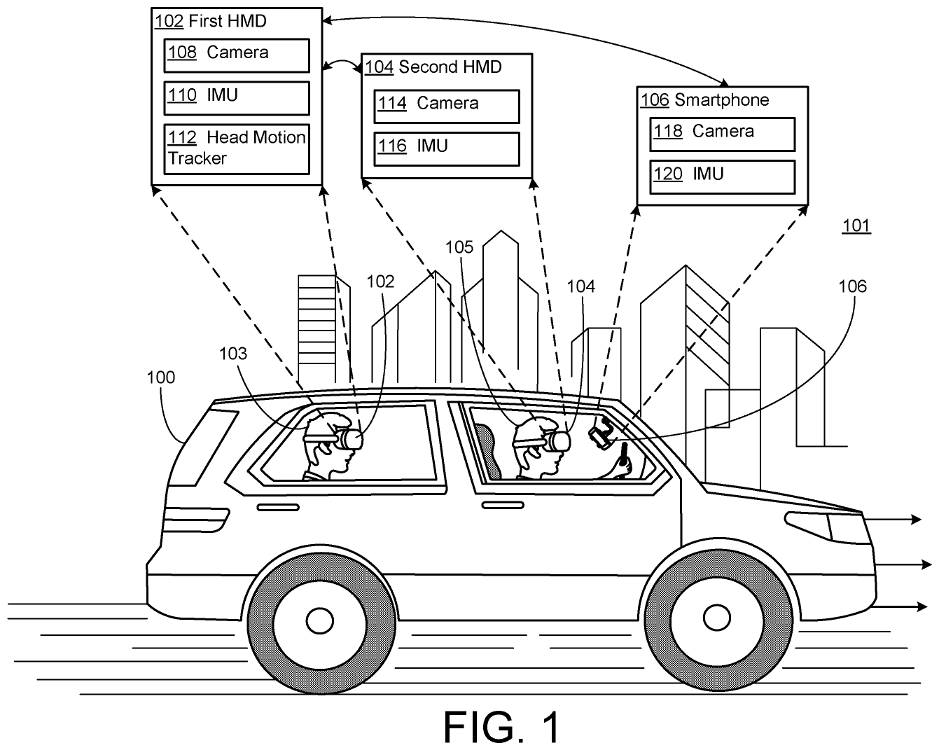

In the example of FIG. 1, a vehicle 100 provides an example of a moving frame of reference of a first HMD 102, relative to an exterior environment 101. That is, the environment 101 represents a stationary or inertial frame (ignoring negligible effects of the earth's rotation), with respect to which the vehicle 100 is moving. The environment 101 is shown as a cityscape for purposes of illustration and discussion, but generally represents any environment through which the vehicle 100 (or other moving frame of reference) may move. The vehicle 100 is illustrated as a car, but may also represent or include other types of vehicles, including, e.g., trains, buses, boats, or airplanes.

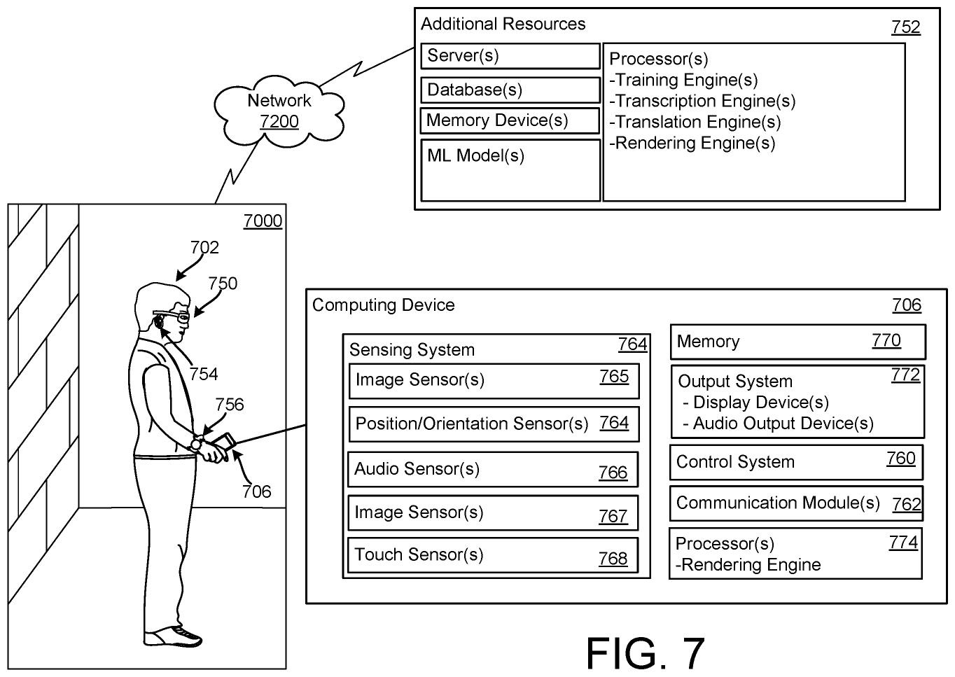

The first HMD 102 is illustrated as an example of a first device used by a first user 103 for motion tracking in the moving frame of reference of the vehicle 100. For example, the first HMD 102 may represent a VR or augmented reality (AR) device, or any type of XR device. Although illustrated as a HMD, the HMD 102 may represent other types of devices, as well, including, e.g., handheld devices such as smartphones, smartwatches, handheld controllers, and various other types of devices, some of which are illustrated and described below, e.g., in the context of FIG. 7.

Motion tracking provided by the first HMD 102 may be provided for any suitable purpose or function of the first HMD 102. For example, head gaze tracking may be provided for purposes of enabling the first user 103 to control a UI of the first HMD 102, or other otherwise control functionalities of the first HMD 102.

Further in FIG. 1, a second HMD 104 is illustrated as being worn by a second user 105. A smartphone 106 is illustrated as being mounted to a windshield of the vehicle 100. As with the first HMD 102, the second HMD 104 and the smartphone 106 should be understood to represent examples of any suitable device(s) that may be used to provide some or all of the functionalities described herein, and related functionalities (e.g., an XR controller(s)). For example, each of the HMD 104 and the smartphone 106 may include, or be coupled to, an image sensor and/or an inertial measurement unit (IMU), or other suitable motion sensor(s).

In more detail, with respect to the exploded views of the first HMD 102, the second HMD 104, and the smartphone 106, the first HMD 102 may be understood to include a camera 108 or other image sensor, an IMU 110, and a head motion tracker 112. The second HMD 104 may also include a camera 114 and an IMU 116, while the smartphone 106 is illustrated as including a camera 118 and an IMU 120.

The smartphone 106 may be mounted to the vehicle 100 using any suitable mounting technique, with the camera 118 of the smartphone 106 directed outside of the vehicle 100 and positioned to capture images of the environment 101. For example, the smartphone 106 may be mounted to a car windshield or window using a mounting bracket and/or adhesive.

The camera 118 may represent two or more cameras of the smartphone 106. For example, the camera 118 may represent a frontside camera or a backside camera. For example, the smartphone 106 may be positioned with the backside camera facing outside of the vehicle 100 and the frontside camera facing inside of (e.g., towards an interior) of the vehicle 100.

The second HMD 104 may be in wireless connection with the first HMD 102. Similarly, the smartphone 106 may be in wireless connection with the first HMD 102. For example, a Bluetooth connection or any suitable wireless connection or pairing may be established.

As referenced above, the first HMD 102 may utilize inputs from either or both of the second HMD 104 and the smartphone 106 to facilitate accurate operations of the head motion tracker 112. For example, the head motion tracker 112 may be used to provide any available functionality, such as gaze tracking or other types of user interface control.

In more particular examples, the head motion tracker 112 may implement visual odometry, e.g., visual inertial odometry (VIO), which combines inputs from the camera 108 and the IMU 110 from within individual corresponding frames. When using VIO within the moving vehicle 100, the IMU 110 will measure motion signals from both the HMD 102 and the vehicle 100, while the camera 108 may measure only motion signals associated with a field of view of the user 103 within an interior of the vehicle 100. As a result, operations of the head motion tracker 112 may be disrupted, and an accuracy of head motion tracking may be reduced.

In FIG. 1, however, in a first example embodiment, the first HMD 102 and the smartphone 106 may be used in conjunction with one another to provide accurate head motion tracking for the first HMD 102. For example, the head motion tracker 112 may receive motion data from the IMU 120 of the smartphone 106. Then, when implementing VIO at the first HMD 102, the head motion tracker 112 may use image data captured by the camera 108, in conjunction with motion data from the IMU 120, to isolate desired head motion data from motion data of the moving vehicle 100. For example, as described in more detail, below, the head motion tracker 112 may use image data from the camera 108 to construct at least a partial map of an interior of the moving vehicle 100, including the smartphone 106. A resulting map may be used to determine relative positions of the HMD 102 and the smartphone 106, which may then be used in conjunction with other collected data to determine, e.g., a centripetal acceleration of the HMD 102 that is due to head motions of the user 103 as compared to centripetal acceleration due to a motion of the moving vehicle 100.

In a second example embodiment, the head motion tracker 112 may receive image data in addition to IMU data from the smartphone 106. For example, the smartphone 106 may also implement VIO, and the head motion tracker 112 may subtract VIO motion data obtained from the smartphone 106 from VIO motion data obtained using the camera 108 and the IMU 110 of the first HMD 102.

In the first and second example embodiments just referenced, as described in more detail, below, a state of the HMD 102 (e.g., position and orientation) may be determined using a state estimation module of the head motion tracker 112. For example, a filter, such as may be used to provide state estimation, may be used. As another example, a Kalman filter (KF), such as an extended Kalman filter (EKF), may be used to provide state estimation.

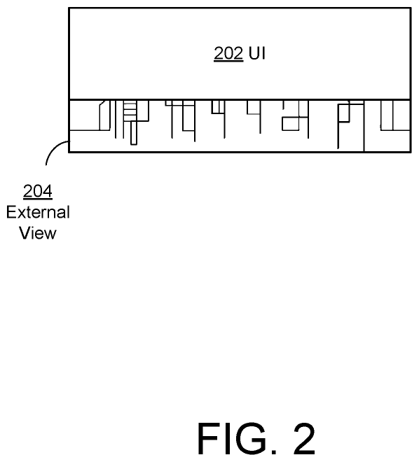

In addition, image data captured from outside of the vehicle 100, such as image data of the environment 101 captured by the smartphone 106, may be used to reduce or eliminate motion sickness experienced by the user 103 (or the user 105). For example, FIG. 2 illustrates an example user interface (UI) 202 that might be experienced by the user 103. For the sake of simplicity, no content is illustrated with respect to the UI 202, although any suitable or desired content may be rendered or otherwise provided.

Further in FIG. 2, an external view 204 is provided in conjunction with the UI 202. That is, as referenced above and as shown with respect to FIG. 1, the external view 204 may include a portion of a captured image(s) of the environment 101.

Thus, the external view 204 provides a constant frame of reference or point(s) of reference for the user 103, similar to the manner in which a view of a shoreline may provide a constant frame of reference for a passenger on a boat. As a result, and just as the hypothetical boat passenger avoids seasickness, the user 103 may avoid motion sickness that might otherwise result from use of the HMD 102 within the vehicle 100.

In the example of FIG. 2, the external view 204 is illustrated as a partial view of the environment 101. In other examples, the external view 204 may be provided as being partially or completely superimposed on the UI 202, with a desired (e.g., configurable) level of transparency. Conversely, the UI 202 may be partially or completely superimposed on the external view 204, again with a desired level of transparency. In other examples, the external view 204 may be positioned on a side(s) or top of the UI 202. In other examples, an artificial version of the external view 204 may be generated, which may relate to other content of the UI 202 and which may be correlated visually with the external view 204 to reduce motion sickness of the user 103.

Returning to FIG. 1, in a third embodiment, the second HMD 104, perhaps in conjunction with the first HMD 102, may be configured to identify common landmarks within the vehicle 100 viewable by both the first HMD 102 and the second HMD 104, and/or may be configured to generate a map of an interior of the vehicle 100. The landmark(s) and/or map may then be used by a state estimation module to determine a correct state (e.g., position or orientation) of the HMD 102.

For example, as referenced above, such a state estimation module may be implemented using a Kalman filter, such as a joint Kalman filter. For example, as described in more detail, below, IMU measurements of the IMUs 110, 116 may be used to predict a future state of the HMD 102, while image data captured by the cameras 108, 114 (e.g., common landmark(s) or map(s)) may be used to measure an actual state of the HMD 102. Accordingly, a residual loss may be determined between the predicted and measured states, so that recursive filtering may be performed to track the state of the HMD 102 over time.

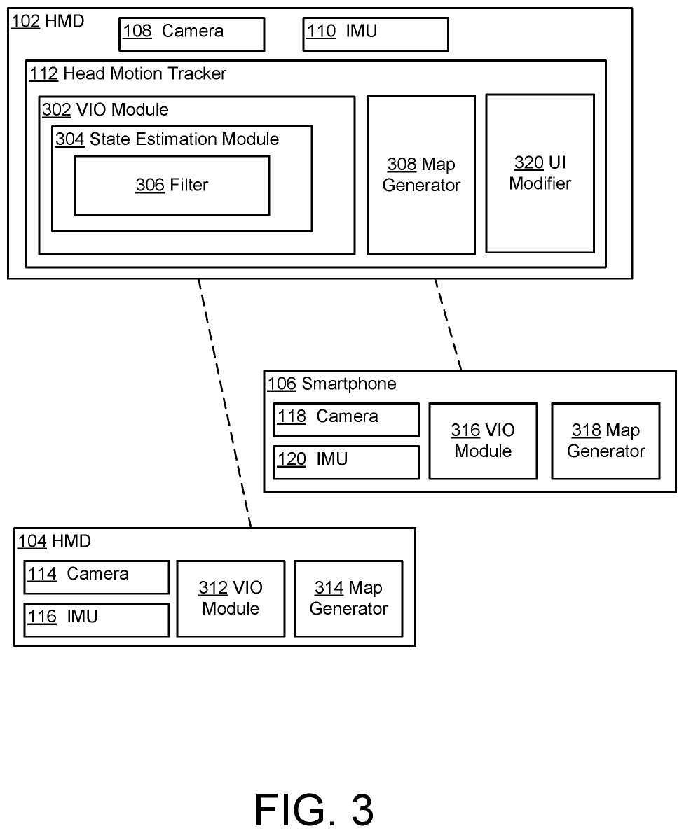

FIG. 3 is a block diagram illustrating an example architecture for use in providing the example implementations of FIG. 1. In the example of FIG. 3, the head motion tracker 112 is illustrated as including a visual inertial odometry (VIO) module 302, which includes a state estimation module 304. In FIG. 3, the state estimation module is implemented as a filter 306, e.g., a Kalman filter, but other types of state estimation modules may be used, as well. A map generator 308 refers to one or more components used to recognize visual landmarks and relate the visual landmarks to one another in the context of a unified map, such as when constructing a map of an interior of the vehicle 100 of FIG. 1, as referenced above and described in more detail, below.

As further illustrated in FIG. 3, the HMD 104 may also include a VIO module 312 and a map generator 314. The smartphone 106 may also include a VIO module 316 and a map generator 318.

The VIO module 302 may be configured to use image data from the camera 108 and IMU data from the IMU 110, perhaps in conjunction with map data from the map generator 308, to perform motion tracking operations of the head motion tracker 112, as described above. For example, the head motion tracker 112 may enable the user 103 to use various UI functions of the HMD 102.

As also described above, the head motion tracker 112 may use data from the HMD 104 and/or the smartphone 106 to remove motion artifacts that are not related to head motions of the user 103, but that result from movements of the moving frame of reference resulting, e.g., from movements of the vehicle 100. Consequently, the user 103 may use the HMD 102 in a desired, expected manner, notwithstanding the fact that the user 103 is within the moving frame of reference, and not stationary.

In more detail, the VIO module 302 may perform fusion of visual odometry performed using image data from the camera 108 and inertial odometry performed using motion data from the IMU 110. In general, visual odometry refers to the analysis of successive image frames, including, e.g., extracting image features and then matching the extracted image features between frames using rotation/translation matrices to characterize a motion of the camera 108 (and thus of the HMD 102).

Meanwhile, inertial odometry refers to use of components of the IMU 110 to determine a motion of the IMU 110 (and thus of the HMD 102). For example, the IMU 110 may include a gyroscope, accelerometer, and/or magnetometer.

Accelerometer measurements may include multiple acceleration components. For example, such acceleration components may include an acceleration of a center of mass or rotation center, a centripetal acceleration that depends on a distance from the rotation center, and a gravitational acceleration.

Thus, visual odometry and inertial odometry may be used independently to capture and characterize motion data, and the VIO module 302 fuses visual odometry and inertial odometry results to obtain more accurate and reliable motion data. For example, measurements from the IMU 110 may be associated with both a bias and noise components. Moreover, the bias component may be prone to drift over time, resulting in drift being included in outputs of the IMU 110. Though processing required to perform visual odometry may be more intensive than is required for inertial odometry, inclusion of visual odometry enables greater accuracy and minimization of biases and noise in final outputs of the head motion tracker 112.

For example, the state estimation module 304 may be configured to output a current state of the HMD 102, including a position, velocity, and orientation of the HMD 102. As described above with respect to FIG. 1, the state of the HMD 102 should be determined with respect to the frame of reference of the moving vehicle 100, and without including the separate motion of the vehicle 100 itself, to ensure accurate and reliable use of the HMD 102 by the user 103.

Consequently, the state estimation module 304 may use motion data from either or both of the HMD 104 and/or the smartphone 106 to remove motion components that result from the motion of the vehicle 100. For example, as shown, each of the HMD 104 and the smartphone 106 may include components similar to those of the HMD 102, the operation of which may be understood from the included descriptions of corresponding components of the HMD 102.

In the following examples, gyroscopic measurements are referenced with respect to a rotational measurement, referred to as omega or @. Omega may be determined with respect to a position vector p, a velocity vector v, and an orientation vector q (which may be represented as a quaternion). Accelerometer measurements may be abbreviated as accel, a, or a, sometimes with additional notations to indicate differences between center of mass acceleration and centripetal acceleration.

Further notations may be used to reference a relevant frame of reference. For example, a_v may be used to notate an acceleration of the vehicle 100, or ω_v may be used to notate a rotation of the vehicle 100.

Both rotation and acceleration measurements may be captured by visual odometry, as well as by a gyroscope and accelerometer of the IMU 110 (or of IMUs 116, 120). Also by way of notation, in the following description, the HMD 102 is referred to as an example device 1, first device, or primary device, while either of the HMD 104 or the smartphone 106 may be referred to as an example device 2, second device, or secondary device.

The map generator 308 may be configured to identify landmarks within an interior of the vehicle 100 and/or generate a map, with a corresponding map coordinate system, of the interior of the vehicle 100. For example, the map generator 308 may utilize a mapping algorithm, such as the simultaneous localization and mapping (SLAM) algorithm. As described herein, the map generator 308 may interact with the map generator 314 and/or the map generator 318 to generate a desired map for use, e.g., by the state estimation module 304 in determining a current state of the HMD 102.

For example, the map generator 308 may interact with the map generator 314 (or the map generator 318) to identify common landmarks from image features identified within image frames. By establishing common landmarks within an interior of the vehicle 100, a map coordinate system may be determined that is common to the corresponding pair of devices 102/104 or 102/106 used to construct the map. By way of notation, such landmarks may be referenced as Lij, where i refers to the device (e.g., device 1 or device 2) and j refers to an identified landmark. Thus, for example, L₁₁ and L₂₁ may refer to a single identified landmark identified by both the HMD 102 and the HMD 104.

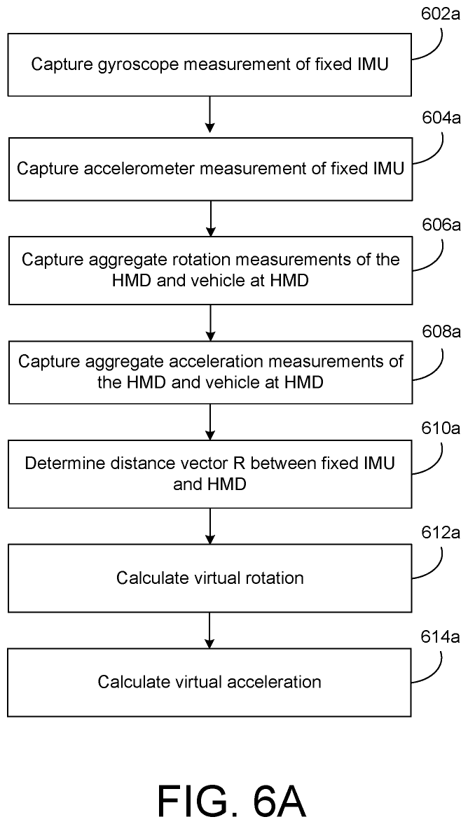

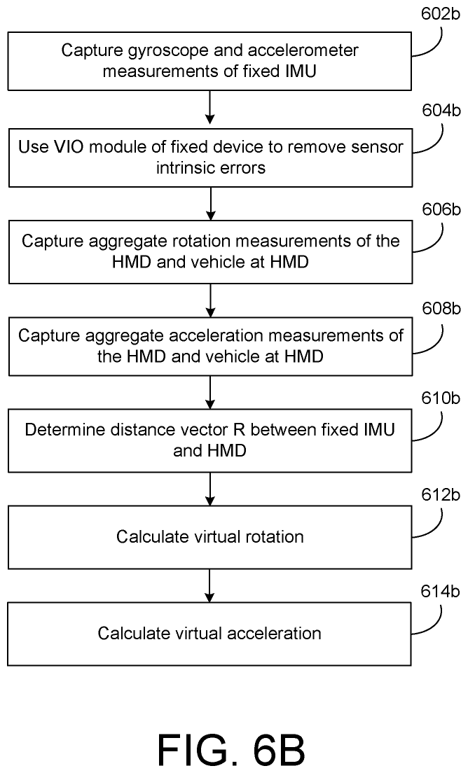

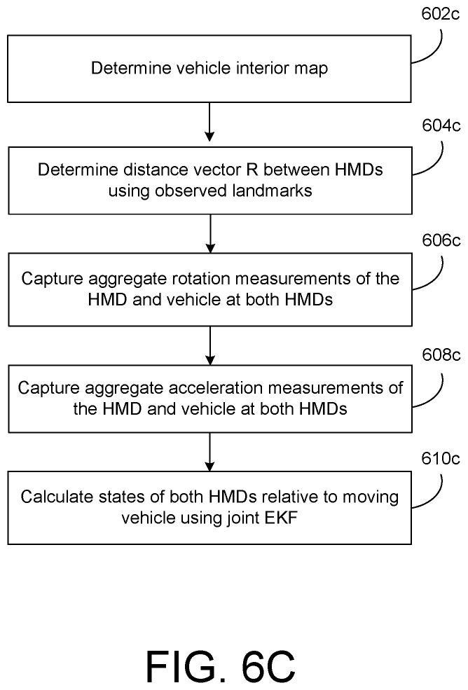

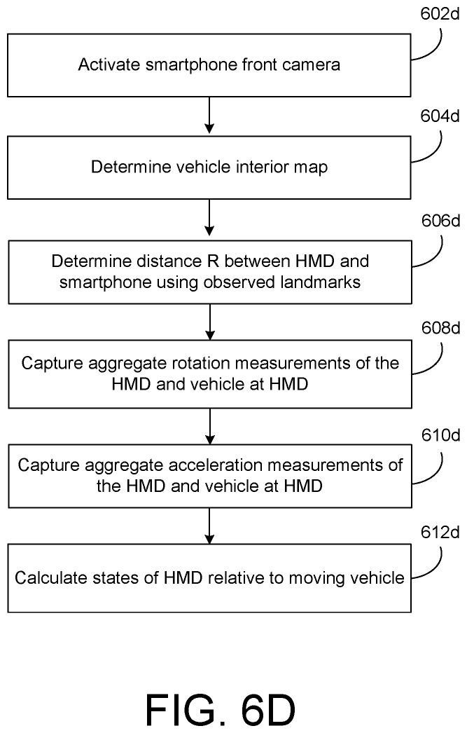

In a first example implementation(s), illustrated and described in more detail below with respect to FIG. 6A, the smartphone 106 may be rigidly mounted to an interior of a moving vehicle, such as a plane, boat, car, bus, or train. In these examples, the IMU 120 of the smartphone 106 may collect vehicular motion data (e.g., rotation/acceleration data) characterizing a motion of the HMD 102 with respect to the motion of the vehicle 100 (or other moving frame of reference). The smartphone 106 may transmit the vehicular motion data to the head motion tracker 112, and the vehicular motion data may be subtracted from motion data calculated by the VIO module 302 to obtain HMD motion data.

In a second example implementation(s), illustrated and described in more detail below with respect to FIG. 6B, the smartphone 106 may be rigidly mounted to an interior of a moving vehicle, with the camera 118 directed outside of the moving vehicle. In these examples, the VIO module 316 of the smartphone 106 may collect vehicular motion data (e.g., rotation/acceleration data) characterizing a motion of the HMD 102 with respect to the motion of the vehicle 100. As in the first example embodiment, the smartphone 106 may transmit the vehicular motion data to the head motion tracker 112, and the vehicular motion data may be subtracted from motion data calculated by the VIO module 302 to obtain HMD motion data.

In this second example embodiment, as described with respect to FIG. 2, a UI modifier 320 of the HMD 102 may be configured to utilize video captured from outside of the vehicle 100 to reduce a motion sickness of the user 103. For example, a portion of the captured video may be included in, shown together with, or superimposed over a UI of the HMD 102. By providing a frame of reference to the user 103 that is consistent with the motion of the vehicle 100 being experienced by the user 103, described embodiments may reduce motion sickness experienced by the user 103.

In a third example implementation(s), illustrated and described in more detail below with respect to FIG. 6C, the HMD 104 may be worn by a second user, e.g., the user 105 of FIG. 1. In these examples, the VIO module 312 of the HMD 104 execute a joint Kalman filter with the VIO module 302 of the HMD 102, with respect to map data of an interior of the vehicle 100 as determined by the map generator 308 of the HMD 102 and by the map generator 314 of the HMD 104. In these examples, vehicular motion data may be jointly removed from head motion tracking of each of the HMD 102 and the HMD 104.

In a fourth example implementation(s), illustrated and described in more detail below with respect to FIG. 6D, the smartphone 106 may be rigidly mounted to an interior of a moving vehicle, with the camera 118 directed inside of the moving vehicle. In these examples, the VIO module 316 of the smartphone 106 may collect vehicular motion data (e.g., rotation/acceleration data) characterizing a motion of the HMD 102 with respect to the motion of the vehicle 100. As in the third example embodiment, the VIO module 316 of the smartphone 106 and the VIO module 302 of the HMD 102 may execute a joint Kalman filter, with respect to map data of an interior of the vehicle 100, as determined by the map generator 308 of the HMD 102 and by the map generator 318 of the smartphone 106.

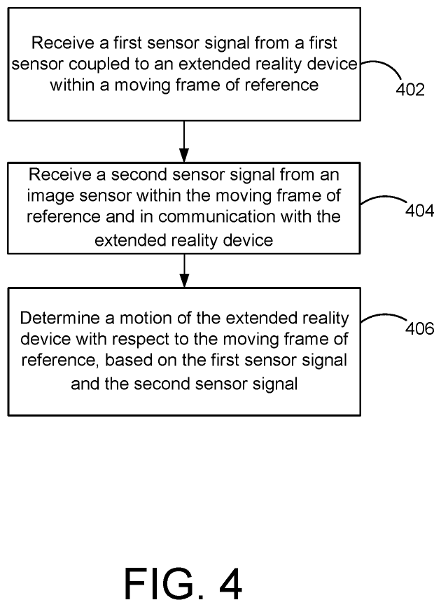

FIG. 4 is a flowchart illustrating example operations of the system of FIG. 2. In the example of FIG. 4, operations 402-406 are illustrated as separate, sequential operations. In various example implementations, however, the operations 402-406 may occur in a different order than that shown, or may be executed in a partially or completely parallel or overlapping manner, or in a nested, iterative, looped, or branched fashion. In other example implementations, one or more operations or suboperations may be omitted, or may be substituted for a different operation or suboperation.

In FIG. 4, a first sensor signal from a first sensor coupled to an extended reality device within a moving frame of reference may be received (402). For example, the first HMD 102 may receive one or more first sensor signals from camera 108 and/or IMU 110, e.g., as part of a state estimated by the VIO module 302.

A second sensor signal may be received from an image sensor within the moving frame of reference and in communication with the extended reality device (404). For example, the first HMD 102 may receive motion data from the smartphone 106 that includes, or is based on, image data captured by the camera 118 of the smartphone 106 (perhaps in conjunction with motion data captured by the IMU 120 of the smartphone 106, such as when the VIO module 316 provides motion data). For example, as described herein, the smartphone 106 may be rigidly mounted to a frame of the vehicle 100, and the camera 118 may include a front-facing camera that is facing an interior of the vehicle 100, and/or may include a back-facing camera that is facing outside of a window of the vehicle 100. In the latter case, captured video from outside of the vehicle 100 may be used in conjunction with a UI of the HMD 102 to reduce motion sickness of the user 103.

In other examples, the first HMD 102 may receive motion data from the second HMD 104 that includes, or is based on, image data captured by the camera 114 of the second HMD 104. Such image data may be received in conjunction with motion data captured by the IMU 116 of the second HMD 104, such as when the VIO module 312 provides motion data.

A motion of the extended reality device with respect to the moving frame of reference may be determined, based on the first sensor signal and the second sensor signal (406). For example, as referenced above and described below with respect to FIGS. 6A and 6B, motion data from the smartphone 106 may be subtracted from motion data determined by the VIO module 302 to provide accurate head motion tracking for the first HMD 102. In other examples, as described below with respect to FIGS. 6C and 6D, a current state (e.g., position and orientation) of the first HMD 102 may be determined through the use of a joint Kalman filter.

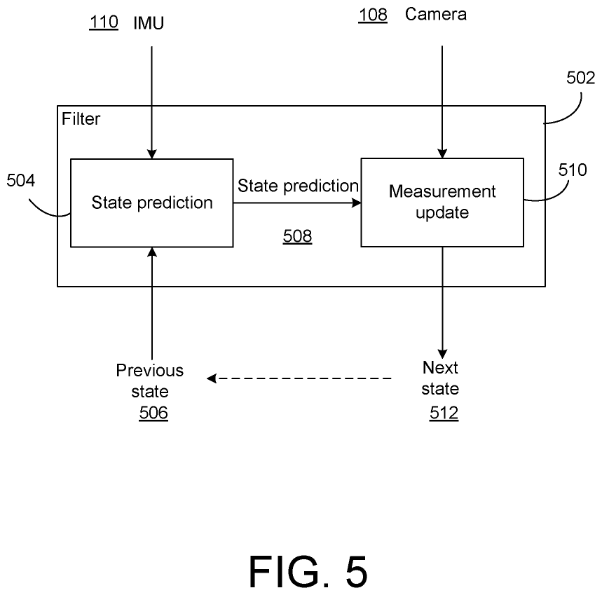

FIG. 5 is a block diagram of a state estimation system that may be used in the examples of FIGS. 1-4. In the example of FIG. 5, a filter 502, e.g., a Kalman filter, e.g., an extended Kalman filter (EKF), is illustrated that may represent an example of the filter 306 of the HMD 102 in FIG. 3. However, as referenced above and described below with respect to FIGS. 6A-6D, various modifications of the filter 502 may be used in the different example embodiments described herein, or in other embodiments.

In the example of FIG. 5, a state prediction 504 for the first HMD 102 may be generated based on motion data from the IMU 110 and on a previous state 506, to thereby obtain a predicted state 508. A measurement from the camera 108 may then be used with the predicted state 508 to determine a measurement update 510. The measurement update 510 thus provides a next state 512.

For example, conceptually, the next state 512 may be determined to have a value that is between a measured state (not shown separately or explicitly in FIG. 5) determined by the camera 108 and the predicted state 508. Weight(s) given to each of the measured state and the predicted state 508 may be determined by various factors, such as an amount of bias or noise present in a given input(s) from the IMU 110 and/or the camera 108.

As shown in FIG. 5, this processing may continue recursively and iteratively to continuously determine state information regarding the first HMD 102. As referenced above, and described in more detail below with respect to FIGS. 6A-6D, the filter 502 of FIG. 5 may also incorporate motion data from one or more of the camera 114 and/or the IMU 116 of the second HMD 104, and/or motion data from one or more of the camera 118 and/or the IMU 120 of the smartphone 106.

FIG. 6A is a flowchart illustrating example implementations using a device rigidly fixed to a moving vehicle. In the example of FIG. 6A, the vehicle 100 is assumed to be an airplane, the motion of which is measured by an IMU attached to an interior wall of the airplane as an example of the IMU 120 of the smartphone 106.

In other examples, the IMU 120 may represent an aircraft IMU used for navigation and flight control and rigidly mounted to a body of the airplane. Such IMUs are highly calibrated and exhibit very low levels of noise.

As referenced above, such an IMU may be referred to as a second or secondary IMU providing vehicle or vehicular motion data to the HMD 102. The IMU 110 of the HMD 102 may be referred to as a first or primary IMU, which provides total or aggregate motion data that includes both vehicle motion and HMD motion. Similarly, the camera 118 of the smartphone 106 may be referred to as a second or secondary camera, and the camera 108 of the HMD 102 may be referred to as a first or primary camera.

Therefore, in included notation, motion data associated with the IMU 120 may be referred to as vehicle motion data and/or may be notated with a 2, while motion data associated with the IMU 110 may be referred to as total motion data and notated with a 1. Identified HMD motion data, determined by removing vehicle motion data from total motion data, may be referred to as virtual motion data or dynamic motion data.

In FIG. 6A, gyroscope measurements of the fixed IMU are obtained (602a) to determine a rotation or omega value(s) of the vehicle (e.g., airplane). Similarly, accelerometer measurements of the fixed IMU may be obtained (604a) to determine acceleration value(s) of the vehicle. The accelerometer measurement of the fixed IMU includes the vehicle acceleration (e.g., at a rotation center) as well as acceleration due to gravity and any centripetal acceleration due to a rotation of the vehicle and a distance between the fixed IMU and the rotation center of the vehicle.

The vehicle rotation vector omega_vehicle may be characterized as shown in Eq. 1:

$$omega\_IMU \_ 2 = omega\_vehicle + gyro\_ 2 \_bias + gyro\_ 2 \_noise$$

As shown in Eq. 1, the omega_IMU_2 includes any bias or noise values associated with the fixed IMU.

The vehicle acceleration accel_IMU_2 may be characterized as shown in Eq. 2:

$$accel\_IMU \_ 2 = vehicle\_acceleration \_at rotation\_center + centripetal\_acceleration \_IMU2 + gravity + accel\_ 2 \_bias + accel\_ 2 \_noise$$

As shown in Eq. 2, in addition to the various acceleration components, the accelerometer measurements may include additional bias and noise values.

Further, aggregate rotation measurements of the HMD and the vehicle may be captured at the HMD (606a) using the IMU 110 and/or the camera 108 (e.g., using the VIO module 302). An aggregate rotation vector obtained with the IMU 110 may thus be written as shown in Eq. 3:

$$omega\_IMU \_ 1 = omega\_vehicle + omega\_hmd + gyro\_ 1 \_bias + gyro\_ 1 \_noise$$

Aggregate acceleration measurements of the HMD and the vehicle may be captured at the HMD (608a) using the IMU 110 and/or the camera 108 (e.g., using the VIO module 302). An aggregate acceleration vector obtained with the IMU 110 may thus be written as shown in Eq. 4:

$$accel\_IMU \_ 1 = vehicle\_acceleration \_at \_the rotation\_center + centripetal\_acceleration \_IMU \_ 1 + gravity + acceleration\_hmd + accel\_ 1 \_bias + accel\_ 1 \_noise$$

As referenced above, centripetal acceleration is dependent on both rotation rate and a distance between a device (e.g., the HMD 102 or the smartphone 106) and a rotation center of the vehicle. Thus, the smartphone 106 and the HMD 102 may both experience the same vehicle rotation, but may exhibit different centripetal accelerations that depend on a distance vector R between the smartphone 106 (or other fixed IMU) and the HMD 102.

To determine the distance vector R (610a), the camera 108 and the map generator 308 of the HMD 102 may be used to determine a vehicle interior map, including localizing the HMD 102 with respect to the map and then determining R with respect to a location of the fixed IMU within the map coordinate system. In other implementations, R may be estimated as a Kalman filter state of the filter 306 (when implemented as a Kalman filter) of the VIO module 302, using the vehicle angular motion.

Then, a virtual rotation or virtual omega characterizing movement of the HMD 102 relative to the vehicle movement may be calculated (612a) as a difference between Eq. 3 and Eq. 1 to subtract out the omega_vehicle value, shown as Eq. 5:

$$virtual\_omega = omega\_hmd + ( gyro\_ 1 \_bias - gyro\_ 2 \_bias ) + ( gyro\_ 1 \_noise - gyro\_ 2 \_noise )$$

Similarly, a virtual acceleration characterizing movement of the HMD 102 relative to the vehicle movement may be calculated (614a) as a difference between Eq. 4 and Eq. 2, shown as Eq. 6:

$$virtual\_acceleration = ( centripetal\_acceleration \_IMU1 - centripetal\_acceleration \_IMU2 ) + acceleration\_hmd + ( accel\_ 1 \_bias - accel\_ 2 \_bias ) + ( accel\_ 1 \_noise - accel\_ 2 \_noise )$$

When the fixed IMU is highly calibrated, the gyro_2_bias, gyro_2_noise, accel_2_bias, and accel_2_noise factors may be considered to be negligible. Then, the terms (accel_1_bias-accel_2_bias) and (gyro_1_bias-gyro_2_bias) may be estimated by the HMD VIO module 302 as states of the filter 306.

Further, the term (centripetal_acceleration_IMU_1−centripetal_acceleration_IMU_2) may be determined using Eq. 7:

$$( centripetal\_acceleration \_IMU \_ 1 - centripetal\_acceleration \_IMU \_ 2 ) = omega\_vehicle \hat{} 2 * R$$

When the fixed IMU, IMU_2, is not highly calibrated, relative bias and noise values may be estimated by fixing or mounting the HMD 102 to the body of the vehicle 100, similar to the mounting of the smartphone 106. That is, by isolating and tracking common motion between the HMD 102 and the smartphone 106 caused by movements of the vehicle 100 for a minimum quantity of time, the common vehicle movements may be subtracted out to isolate bias and noise aspects of the measurements, which may then be incorporated into Eqs. 5 and 6.

An example state for the example of FIG. 6A when the vehicle is a plane may be expressed as follows:

### State:

| | |
|---|---|
| [[[ω₂_{_{—}}bias, α₂_{_{—}}bias, base_{2—}g]; | // Current plane bias estimate and gravity vector |
| [base_{1 —}q_IMU₁; base₁_{_{—}}v_IMU₁, base_{1 —}p_IMU₁]; | // Current HMD inertial state |
| [ω_{1—}bias, α_{1—}bias]; | // Current HMD bias estimate |
| [base_{1—}q_base₂; base_{1—}p_base₂]; | // Map alignment extrinsics |
| [base_{1—}p₂; base_{1—}p₁; ...]] | // Map points |

In the above state representation, “base 1” and “base 2” represent non-inertial reference frames, attached to the airplane. They define two coordinate frames, by which the two HMDs measure their position and orientation in space. Generally, the HMDs cannot measure their absolute position and orientation, because there is no absolute reference. Instead, they measure the amount that they have rotated or translated relative to the moment they come online. These relative rotations and translations are written base₁_T_IMU₁ or base₂_T_IMU₂. Also, the relative position and orientation of the two bases (base₂_T_base₁) are not known a priori, and may be established using 3D landmarks visible to both headsets, or airplane maneuvers felt by both IMUs.

An example state function for the example of FIG. 6A may include Eqs. 8-16:

### State Function:

$${ω}_{2} \_corrected = {ω}_{2} - {ω}_{2} \_bias$$

$${α}_{2} \_corrected = {α}_{2} - {α}_{2} \_bias + {base}_{2} \_g$$

$${ω}_{1} \_corrected = {ω}_{1} - {ω}_{1} \_bias - {base}_{1} \_q {\_base}_{2} * {ω}_{2} \_corrected ;$$

$${α}_{1} \_corrected = {α}_{1} - {α}_{1} \_bias - {base}_{1} \_q {\_base}_{2} * {α}_{2} \_corrected$$

$${α}_{1} \_corrected = {α}_{1} - ( {[ {ω}^{′} \_plane ]}_{x} + {[ ω\_plane ]}_{x}^{2} ) ( base\_q {\_IMU}^{- 1} ( base\_p \_plane - base\_p \_IMU ) )$$

$${base}_{2} \_q {\_IMU}_{1} ← {base}_{1} \_q {\_IMU}_{1} * exp ( Δ t {ω}_{1} \_corrected )$$

$${base}_{1} \_v {\_IMU}_{1} ← {base}_{1} \_v {\_IMU}_{1} + Δ t {base}_{1} \_q {\_IMU}_{1} * {α}_{1} \_corrected$$

$${base}_{1} \_p {\_IMU}_{1} ← {base}_{1} \_p {\_IMU}_{1} + Δ t {base}_{1} \_v {\_IMU}_{1}$$

$${base}_{2} \_g ← exp ( Δ t {ω}_{2} \_corrected ) * {base}_{2} \_g$$

The example state function may further include a Visual measurement function as Eq. 17: x₁ⱼ=PerspectiveProjection(base₁_T_IMU₁⁻¹ base₁_p₁ⱼ), which describes the idealized camera projection of the i-th 3D point (p₂ᵢ,given in coordinates relative to frame base₂) onto the 2D image plane attached to IMU 2, yielding a 2D point (x₂ᵢ). In the visual measurement function of Eq. 17, T denotes transform and a change-of-bases identity may be used to rewrite the expression in parentheses as Eq. 18: base₂_T_IMU₂⁻¹ base₂_p₂ᵢ=IMU₂_p₂ᵢ, which gives the coordinates of point p₂ᵢ relative to IMU/Camera 2. The perspective projection then projects the 3d point onto a 2D plane as shown in Eq. 19: PerspectiveProjection(IMU₂_p₂ᵢ)=[IMU₂_p₂ᵢ·x/IMU₂_p₂ᵢ·z; IMU₂_p₂ᵢ·y/IMU₂_p₂ᵢ.z], in which IMU₂_p₂ᵢ.z is the orthogonal component of IMU₂_p₂ᵢ in the direction of the camera axis.

FIG. 6B is a flowchart illustrating example implementations using a device with a camera that is rigidly fixed to a moving vehicle, with the camera facing outside of the moving vehicle. In the example embodiments of FIG. 6B, similar to FIG. 6A, gyroscope and accelerometer measurements of the fixed IMU of the smartphone 106 may be captured (602b). In FIG. 6b, however, through the user of images captured by the smartphone camera 118, the VIO module 316 may be used to remove sensor intrinsic errors, such as bias (604b).

Also as in FIG. 6A, aggregate rotation measurements of the HMD 102 and vehicle motions may be captured at the HMD 102 (606b). Similarly, aggregate acceleration measurements of the HMD 102 and vehicle motions may be captured at the HMD 102 (608b). The distance vector R may also be determined (610b) using the techniques described above with respect to FIG. 6A.

Accordingly, the virtual rotation of the HMD 102 (612b) and the virtual acceleration of the HMD 102 (614b) may be determined using appropriate ones of Eqs. 5-22. A resulting noise sigma value for the virtual measurements may be expressed, e.g., as sqrt(gyro_1_sigma\hat{ }2+gyro_2_sigma\hat{ }2).

FIG. 6C is a flowchart illustrating example implementations using two head-mounted devices. In the example of FIG. 6C, an interior map of the vehicle 100 may be determined (602c). For example, the cameras 108, 114 of the HMDS 102, 104 may be used together with respective map generators 308, 314 to generate the interior map. In other examples, a pre-existing map of the interior may be used.

The distance vector R between the HMDs 102, 104 may be determined using commonly detected landmarks from within the interior map, perhaps in conjunction with the above-described techniques for determining R (604c). Then, aggregate rotation measurements of the HMDs 102, 104 and vehicle motions may be captured at both HMDs 102, 104 (606c). Similarly, aggregate acceleration measurements of the HMDs 102, 104 and vehicle motions may be captured at both HMDs 102, 104 (608c).

Thus, current states of both the HMDs 102, 104 relative to the moving vehicle 100 may be determined using a joint EKF (610c). For example, the states of the joint EKF may be written, using the notations described above, as (p1, v1, q₁, L11, L₁₂ . . . . L2n, a_v, omega_v, p12, q12) for device 1, and (p2, v2, q2, L21, L22 . . . . L2n, a_v, omega_v, p12, q12) for device 2.

Specifically, in the above notation, p is the position vector, v is the velocity vector, q is the orientation vector (e.g., represented by a quaternion), Lij are the landmarks of the images, a_v is the vehicle acceleration, and omega_v is the vehicle rotation rate.

Observations of the joint EKF include 2d landmark coordinates on images captured by the two cameras 108, 114. That is, landmark locations on the map may be used for re-localization as the observations of the joint EKF. The IMU measurements are used for Kalman filter prediction, as explained above with respect to FIG. 5.

An example state for the example of FIG. 6C when the vehicle is a plane may be expressed as follows:

### State:

| | |
|---|---|
| [[baseᵢ_{_{—}}q_IMUᵢ; base_{i—}v_IMUᵢ, base_{i—}p_IMUᵢ]; | // Current inertial state (not shared) |
| [ω_{i—}bias, α_{i—}bias]; | // Current bias estimate (not shared) |
| [base_{i—}q_plane; baseᵢ_{_{—}}p_plane]; | // Map alignment extrinsics (may be shared) |
| [base_{i—}pᵢ₁; base_{i—}pᵢ₂; ...]; | // Map points (may be shared) |
| [ω_plane; α_plane; g_plane]] | // Plane inertial state (shared) |

A corresponding example state function for the example of FIG. 6A is shown in Eqs. 19-26:

### State Function:

$${ω}_{i} \_corrected = {ω}_{i} - {ω}_{i} \_bias - {base}_{i} \_q \_plane * ω\_plane ;$$

$${α}_{i} \_corrected = {α}_{i} - {α}_{i} \_bias - {base}_{i} \_q \_plane * ( α\_plane + g\_plane )$$

$${α}_{i} \_corrected = ( {[ {ω}^{′} \_plane ]}_{x} + {[ ω\_plane ]}_{x}^{2} ) ( {base}_{i} \_q {\_IMU}_{i}^{- 1} ( {base}_{i} \_p \_plane - {base}_{i} \_p {\_IMU}_{i} ) )$$

$${base}_{i} \_q {\_IMU}_{i} ← {base}_{i} \_q {\_IMU}_{i} * exp ( Δ t {ω}_{i} \_corrected )$$

$${base}_{i} \_v {\_IMU}_{i} ← {base}_{i} \_v {\_IMU}_{i} + Δ t {base}_{i} \_q {\_IMU}_{i} * {α}_{i} \_corrected$$

$${base}_{i} \_p {\_IMU}_{i} ← {base}_{i} \_p {\_IMU}_{i} + Δ t {base}_{i} \_v {\_IMU}_{i}$$

$$g\_plane ← exp ( Δ t ω\_plane ) * g\_plane$$

$$Visual measurement function :$$

$${x}_{ij} = PerspectiveProjection ( {base}_{i} \_q {\_IMU}_{2}^{- 1} {base}_{i} {\_p}_{ij} )$$

FIG. 6D is a flowchart illustrating example implementations using a device with a camera that is rigidly fixed to a moving vehicle, with the camera facing inside of the moving vehicle. In FIG. 6D, the camera 118 of the smartphone 106 may represent a front-facing camera that is activated for HMD motion tracking when the smartphone 106 is fixed to a body of the vehicle 100 (602d).

Then, similar to the example of FIG. 6C, the cameras 108, 118 of the first HMD 102 and the smartphone 106, respectively, may be used together with respective map generators 308, 318 to generate an interior map (604d). The distance vector R between the HMD 102 and the camera 118 of the smartphone 106 may be determined using commonly detected landmarks from within the interior map, perhaps in conjunction the above-described techniques for determining R (606d). Then, aggregate rotation measurements of the HMD 102 and vehicle motions may be captured at the HMD 102 (608d). Similarly, aggregate acceleration measurements of the HMD 102 and vehicle motions may be captured at the HMD 102 (610d). States of the HMD 102 relative to the moving vehicle may thus be calculated (612d), e.g., using a joint EKF and associated techniques, and similar to the techniques described above with respect to FIG. 6C.

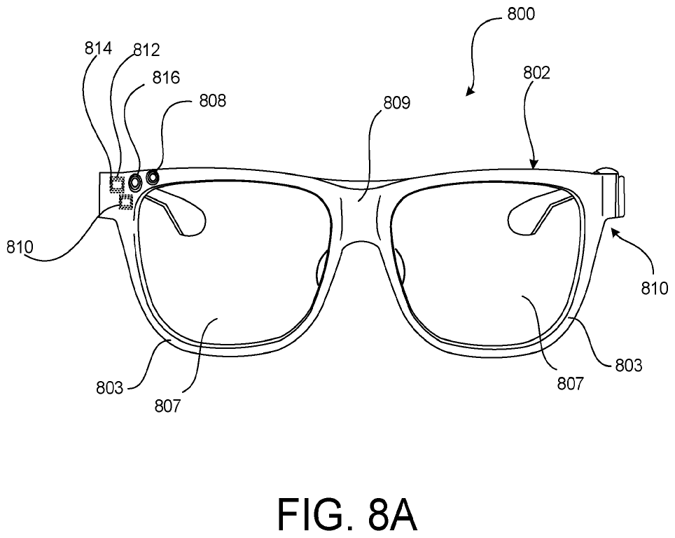

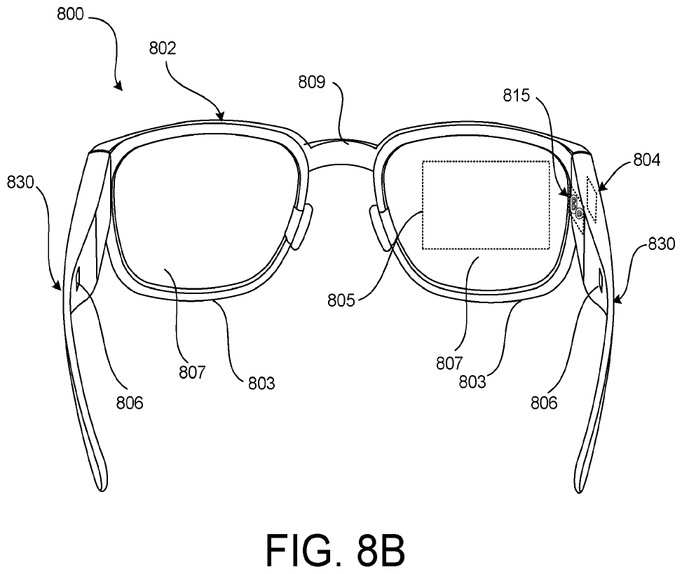

FIGS. 7, 8A, and 8B provide additional example contexts in which described techniques may be implemented, including example smartglasses and other devices/applications.

FIG. 7 is a third person view of a user 702 (analogous to the user 103 of FIG. 1) in an ambient environment 7000, with one or more external computing systems shown as additional resources 752 that are accessible to the user 702 via a network 7200. FIG. 7 illustrates numerous different wearable devices that are operable by the user 702 on one or more body parts of the user 702, including a first wearable device 750 in the form of glasses worn on the head of the user, a second wearable device 754 in the form of ear buds worn in one or both cars of the user 702, a third wearable device 756 in the form of a watch worn on the wrist of the user, and a computing device 706 held by the user 702. In FIG. 7, the computing device 706 is illustrated as a handheld computing device but may also be understood to represent any personal computing device, such as a table or personal computer.

In the example of FIG. 7, the user 702 is illustrated as being stationary. The various aspects and components of FIG. 7, however, including the user 702, should be understood to be potentially positioned in any moving frame of reference, as described above, e.g., with respect to FIG. 1. The various wearable devices described may be used in the techniques described above, and other devices (such as an XR controller device) may be used, as well.

In some examples, the first wearable device 750 is in the form of a pair of smart glasses including, for example, a display, one or more images sensors that can capture images of the ambient environment, audio input/output devices, user input capability, computing/processing capability and the like. Additional examples of the first wearable device 750 are provided below, with respect to FIGS. 8A and 8B.

In some examples, the second wearable device 754 is in the form of an car worn computing device such as headphones, or earbuds, that can include audio input/output capability, an image sensor that can capture images of the ambient environment 7000, computing/processing capability, user input capability and the like. In some examples, the third wearable device 756 is in the form of a smart watch or smart band that includes, for example, a display, an image sensor that can capture images of the ambient environment, audio input/output capability, computing/processing capability, user input capability and the like. In some examples, the handheld computing device 706 can include a display, one or more image sensors that can capture images of the ambient environment, audio input/output capability, computing/processing capability, user input capability, and the like, such as in a smartphone. In some examples, the example wearable devices 750, 754, 756 and the example handheld computing device 706 can communicate with each other and/or with external computing system(s) 752 to exchange information, to receive and transmit input and/or output, and the like. The principles to be described herein may be applied to other types of wearable devices not specifically shown in FIG. 7 or described herein.

The user 702 may choose to use any one or more of the devices 706, 750, 754, or 756, perhaps in conjunction with the external resources 752, to implement any of the implementations described above with respect to FIGS. 1-6. For example, the user 702 may use an application executing on the device 706 and/or the smartglasses 750 to perform head motion tracking when the user 702 is in a moving frame of reference.

The device 706 may access the additional resources 752 to facilitate the various techniques described herein, or related techniques. In some examples, the additional resources 752 may be partially or completely available locally on the device 706. In some examples, some of the additional resources 752 may be available locally on the device 706, and some of the additional resources 752 may be available to the device 706 via the network 7200. As shown, the additional resources 752 may include, for example, server computer systems, processors, databases, memory storage, and the like. In some examples, the processor(s) may include training engine(s), transcription engine(s), translation engine(s), rendering engine(s), and other such processors.

The device 706 may operate under the control of a control system 760. The device 706 can communicate with one or more external devices, either directly (via wired and/or wireless communication), or via the network 7200. In some examples, the one or more external devices may include various ones of the illustrated wearable computing devices 750, 754, 756, another mobile computing device similar to the device 706, and the like. In some implementations, the device 706 includes a communication module 762 to facilitate external communication. In some implementations, the device 706 includes a sensing system 764 including various sensing system components. The sensing system components may include, for example, one or more image sensors 765, one or more position/orientation sensor(s) 764 (including for example, an inertial measurement unit, an accelerometer, a gyroscope, a magnetometer and other such sensors), one or more audio sensors 766 that can detect audio input, one or more image sensors 767 that can detect visual input, one or more touch input sensors 768 that can detect touch inputs, and other such sensors. The device 706 can include more, or fewer, sensing devices and/or combinations of sensing devices. Various ones of the communications modules may be used to control brightness settings among devices described herein, and various sensors may be used individually or together to perform the types of gaze, depth, and/or brightness detection described herein.

Captured still and/or moving images may be displayed by a display device of an output system 772, and/or transmitted externally via a communication module 762 and the network 7200, and/or stored in a memory 770 of the device 706. The device 706 may include one or more processor(s) 774. The processors 774 may include various modules or engines configured to perform various functions. In some examples, the processor(s) 774 may include, e.g, training engine(s), transcription engine(s), translation engine(s), rendering engine(s), and other such processors. The processor(s) 774 may be formed in a substrate configured to execute one or more machine executable instructions or pieces of software, firmware, or a combination thereof. The processor(s) 774 can be semiconductor-based including semiconductor material that can perform digital logic. The memory 770 may include any type of storage device or non-transitory computer-readable storage medium that stores information in a format that can be read and/or executed by the processor(s) 774. The memory 770 may store applications and modules that, when executed by the processor(s) 774, perform certain operations. In some examples, the applications and modules may be stored in an external storage device and loaded into the memory 770.

Although not shown separately in FIG. 7, it will be appreciated that the various resources of the computing device 706 may be implemented in whole or in part within one or more of various wearable devices, including the illustrated smartglasses 750, earbuds 754, and smartwatch 756, which may be in communication with one another to provide the various features and functions described herein.

An example head mounted wearable device 800 in the form of a pair of smart glasses is shown in FIGS. 8A and 8B, for purposes of discussion and illustration. The example head mounted wearable device 800 includes a frame 802 having rim portions 803 surrounding glass portion, or lenses 807, and arm portions 830 coupled to a respective rim portion 803. In some examples, the lenses 807 may be corrective/prescription lenses. In some examples, the lenses 807 may be glass portions that do not necessarily incorporate corrective/prescription parameters. A bridge portion 809 may connect the rim portions 803 of the frame 802. In the example shown in FIGS. 8A and 8B, the wearable device 800 is in the form of a pair of smart glasses, or augmented reality glasses, simply for purposes of discussion and illustration.

In some examples, the wearable device 800 includes a display device 804 that can output visual content, for example, at an output coupler providing a visual display area 805, so that the visual content is visible to the user. In the example shown in FIGS. 8A and 8B, the display device 804 is provided in one of the two arm portions 830, simply for purposes of discussion and illustration. Display devices 804 may be provided in each of the two arm portions 830 to provide for binocular output of content. In some examples, the display device 804 may be a see through near eye display. In some examples, the display device 804 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 807, next to content (for example, digital images, user interface elements, virtual content, and the like) output by the display device 804. In some implementations, waveguide optics may be used to depict content on the display device 804.

The example wearable device 800, in the form of smart glasses as shown in FIGS. 8A and 8B, includes one or more of an audio output device 806 (such as, for example, one or more speakers), an illumination device 808, a sensing system 810, a control system 812, at least one processor 814, and an outward facing image sensor 816 (for example, a camera). In some examples, the sensing system 810 may include various sensing devices and the control system 812 may include various control system devices including, for example, the at least one processor 814 operably coupled to the components of the control system 812. In some examples, the control system 812 may include a communication module providing for communication and exchange of information between the wearable device 800 and other external devices. In some examples, the head mounted wearable device 800 includes a gaze tracking device 815 to detect and track eye gaze direction and movement. Data captured by the gaze tracking device 815 may be processed to detect and track gaze direction and movement as a user input. In the example shown in FIGS. 8A and 8B, the gaze tracking device 815 is provided in one of two arm portions 830, simply for purposes of discussion and illustration. In the example arrangement shown in FIGS. 8A and 8B, the gaze tracking device 815 is provided in the same arm portion 830 as the display device 804, so that user eye gaze can be tracked not only with respect to objects in the physical environment, but also with respect to the content output for display by the display device 804. In some examples, gaze tracking devices 815 may be provided in each of the two arm portions 830 to provide for gaze tracking of each of the two eyes of the user. In some examples, display devices 804 may be provided in each of the two arm portions 830 to provide for binocular display of visual content.

The wearable device 800 is illustrated as glasses, such as smartglasses, augmented reality (AR) glasses, or virtual reality (VR) glasses. More generally, the wearable device 800 may represent any head-mounted device (HMD), including, e.g., goggles, helmet, or headband. Even more generally, the wearable device 800 and the computing device 706 may represent any wearable device(s), handheld computing device(s), or combinations thereof.

Use of the wearable device 800, and similar wearable or handheld devices such as those shown in FIG. 7, enables useful and convenient use case scenarios of implementations of FIGS. 1-6. For example, the wearable device 800 may incorporate an IMU for use in performing the types of head tracking described herein, and in conjunction with other relevant hardware and software of the wearable device 800.

In additional or alternative implementations, controller tracking with ultrawideband sensors is provided. Extended Reality (XR) devices typically provide a user interface (UI). Various types of UI control exist that are compatible with UIs of XR devices. For example, UI control may be implemented using physical buttons, image-based gesture recognition, or through the use of separate devices (e.g., handheld controllers).

Described techniques enable use of an ultrawideband (UWB) sensor for XR device control. For example, one or more UWB sensors may be used in conjunction with an inertial measurement unit (IMU) or other motion sensor to provide XR device control. For example, sensor fusion may be performed to fuse outputs of a UWB sensor and an IMU to obtain low-latency, low-cost, and accurate XR device control. One or more cameras and associated LEDs may be used as well, e.g., for initialization, calibration, and/or additional motion sensing. In addition, multiple UWB devices may be used together, devices other than UWB sensor(s) may be used, and described controllers may be used for controlling computing devices other than XR headsets.

In a general aspect, a method includes receiving a first signal from a first motion sensor that includes an ultrawideband (UWB) sensor, receiving a second signal from a second motion sensor, determining, based on the first signal and the second signal, a position and orientation of a controller, and controlling a computing device based on the position and orientation of the controller.

In another general aspect, a computer program product is tangibly embodied on a non-transitory computer-readable storage medium and comprises instructions. When executed by at least one computing device (e.g., by at least one processor of the at least one computing device), the instructions are configured to cause the at least one computing device to receive a first signal from a first motion sensor that includes an ultrawideband (UWB) sensor and receive a second signal from a second motion sensor. When executed by at least one computing device (e.g., by at least one processor of the at least one computing device), the instructions are configured to cause the at least one computing device to determine, based on the first signal and the second signal, a position and orientation of a controller, and control a computing device based on the position and orientation of the controller.

In another general aspect, a device includes a first motion sensor that includes an ultrawideband (UWB) sensor, at least one processor, and at least one memory, the at least one memory storing a set of instructions, which, when executed, cause the at least one processor to receive a first signal from the first motion sensor, receive a second signal from a second motion sensor, determine, based on the first signal and the second signal, a position and orientation of a controller, and provide control of an extended reality (XR) headset based on the position and orientation of the controller.

The details of one or more implementations are set forth in the accompanying drawings and the description below. Other features will be apparent from the description and drawings, and from the claims.

Described systems and techniques enable device control. For example, a combination of motion sensors of one or more types, such as UWB sensors, IMU sensors, or cameras may be used to track a position and orientation of a controller in space, which may then be used to control interactions with, and operations of, a computing device(s).

Described systems and techniques enable XR device control using UWB sensors. For example, a user interface (UI) of a head-mounted device (HMD), such as a virtual reality (VR) or augmented reality (AR) device, may be controlled by a handheld controller in a fast, accurate, and reliable manner.

Existing XR device controllers may utilize one or more IMUs for XR device control. Such IMUs may be inexpensive and responsive, but may be prone to drift and other sources of inaccuracy.

It is possible to reduce errors from IMU drift through the use of one or more cameras on the XR device and/or XR device controller, perhaps in conjunction with associated LEDs. For example, a camera may be used in conjunction with an IMU to perform visual inertial odometry (VIO) and/or a camera may be used to construct a map of the XR device environment using an algorithm such as the simultaneous localization and mapping (SLAM) algorithm. Additionally, or alternatively, LEDs may be mounted to one of the XR device or the XR device controller in a defined pattern or in defined positions, so that a camera mounted on the other of the XR device or the XR device controller may use the LEDs to perform tracking of the XR device controller with respect to the XR device. The use of such cameras and/or LEDs, however, may require additional processing and/or power resources, while also potentially introducing additional latency.

Thus, existing techniques for XR device control have at least the technical problems of controller drift leading to inaccurate XR device control. Existing techniques have at least the additional technical problems of using additional hardware (e.g., cameras, LEDs) with excessive processing and/or power resource consumption to attempt to resolve the controller drift problem.

The technical solutions described herein for the above-referenced and related technical problems provide fast, accurate XR device control, using one or more UWB sensors in conjunction with at least one IMU or other motion sensor. Technical solutions described herein utilize sensor fusion to fuse UWB and IMU outputs and thereby mitigate potential sources of inaccuracy from both of the UWB/IMU outputs.

For example, UWB sensors may exhibit jitter, but are generally not prone to drift. IMUs, in contrast, may provide fast and highly accurate position and orientation information in the short term, but are prone to exhibiting drift over time. UWBs have relatively lower accuracy and precision, while IMUs have higher accuracy and precision that degrade over time as a result of accumulated errors. Through the use of sensor fusion to combine UWB and IMU outputs, high-accuracy, low-latency, stable measurements may be obtained, in which the relatively more-stable, less-accurate outputs of the UWB sensor are balanced by the relatively less-stable, more accurate outputs of the IMU sensor.

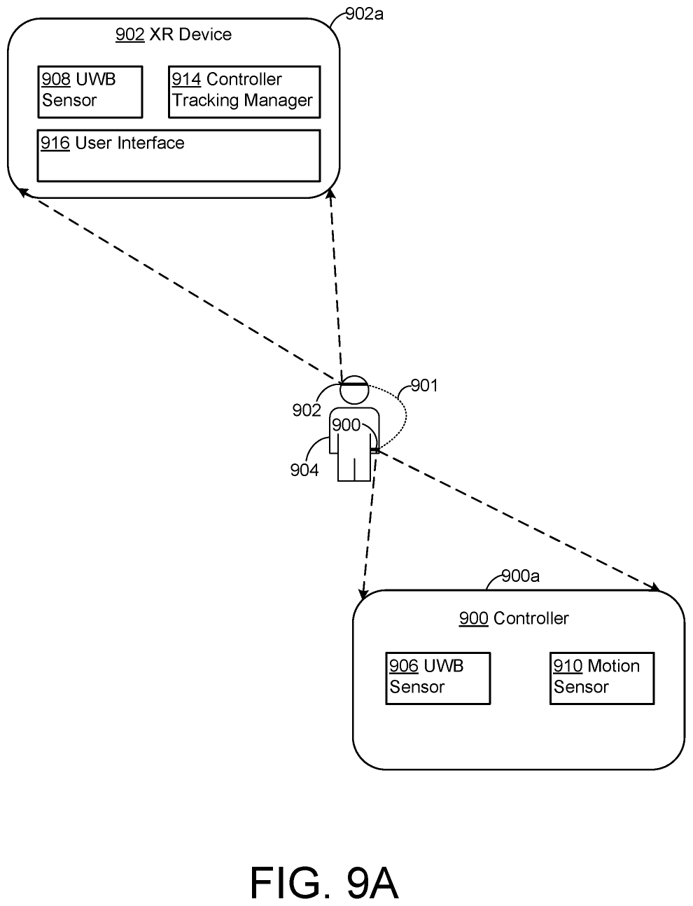

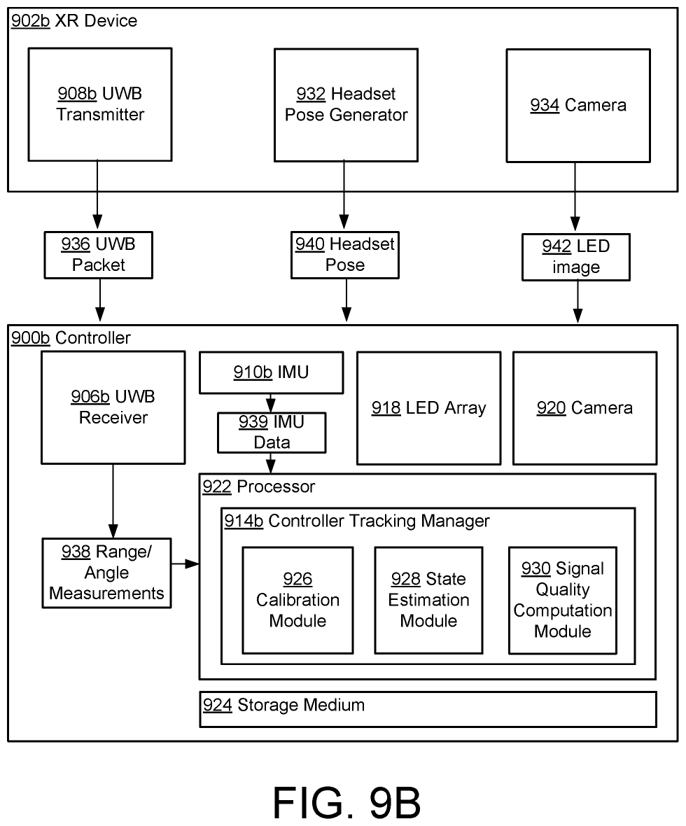

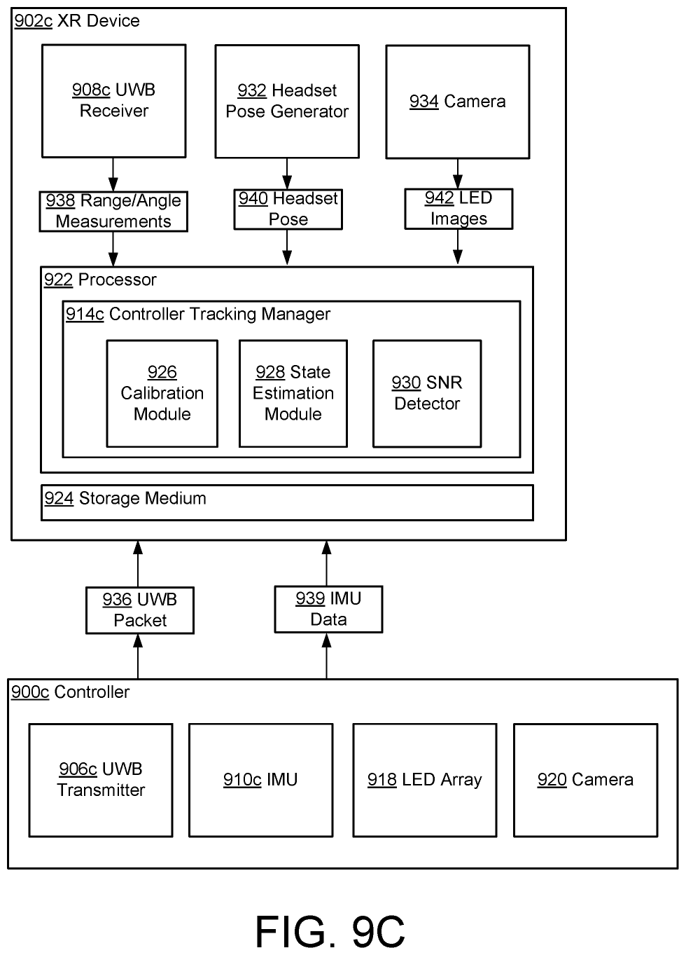

FIG. 9A illustrates an example implementation of a system for XR device controller tracking using ultrawideband (UWB) sensors. In FIG. 9A, a controller 900, also referred to as a XR controller or XR device controller, may share a connection 901 (e.g., may be paired with) an XR device 902.

As shown, both the controller 900 and the XR device 902 may be worn or held by a user 904. For example, the XR device 902 may represent glasses, goggles, or other types of head-mounted devices (HMDs). The controller 900 may represent, e.g., any type of handheld controller compatible with the XR device 902. The controller 900 may be a specialized controller designed for operation with the XR device 902, or may be a more generic device, such as a smartphone or smartwatch, which may be adapted for use in controlling the XR device 902.

FIG. 9A further illustrates an exploded view 900a of the controller 900, and an exploded view 902a of the XR device 902. As shown, a UWB sensor 906 is illustrated in the exploded view 900a of the controller 900, which has a counterpart UWB sensor 908 illustrated in the exploded view 902a of the XR device 902. A motion sensor 910 is illustrated in the exploded view 900a of the controller 900, which may represent, e.g., an IMU, a camera, or other motion sensor.

The exploded view 902a of the XR device 902 further illustrates a controller tracking manager 914. As referenced above, and described in more detail, below, the controller tracking manager 914 may be configured to perform sensor fusion of outputs of the UWB sensors 906/908 and of the motion sensor 910, in order to provide tracking of the controller 900.

For example, the controller tracking manager 914 may perform recursive filtering in the context of an extended Kalman filter (EKF) to provide state estimation for the controller 900, to thereby provide successive states of the controller 900. For example, a state of the controller 900 may be defined with respect to a position and orientation of the controller 900, including, e.g., a range (distance) and angle defined between the UWB sensor 906 and the UWB sensor 908.

In FIG. 9A, the controller tracking manager 914 is illustrated at the XR device 902. In other example implementations, described below, the controller tracking manager 914 may be implemented at the controller 900. In other implementations, the controller tracking manager 914 may be partially implemented at the XR device 902 and partially at the controller 900.

UWB sensors 906/908 constitute a pair of sensors in which one sensor acts as a transmitter, while the other acts as a receiver. In conventional uses of UWB sensors, a UWB tag transmits time-stamped packets that are received by UWB anchors. The UWB anchor(s) may then determine a time-of-flight (ToF) of each packet to thereby determine a distance between the tag and the anchor. Further, a relative angle between the tag and the anchor may be determined to provide directional information characterizing a location of the anchor, relative to the tag. In such conventional settings, the location/direction of the anchor may be specified to an order of magnitude of centimeters, which is typically sufficient for conventional UWB use case scenarios, such as locating a lost item.

In the example of FIG. 9A, either of the UWB sensors 906, 908 may be implemented as the transmitter, or as the receiver. Although a single UWB sensor is shown at each of the controller 900 and the XR device 902, example embodiments may implement two or more UWB sensors. Similarly, two or more of the motion sensor 910 (e.g., two or more IMUs, or two or more cameras, or an IMU and a camera) may be used at the controller 900. Additionally, although not shown in FIG. 9A, one or more additional motion sensors may be implemented at the XR device 902. For example, one or more cameras may be implemented at the XR device 902.

Thus, the controller tracking manager 914 may utilize the controller 900, in conjunction with at least the UWB sensor 908, to control operations of the XR device 902. For example, as referenced above and illustrated in FIG. 9A, the user 904 may use the controller 900 to control operations of a user interface 916 of the XR device 902.

For example, as described herein, a position and/or orientation of the controller 900 may be used to control a cursor or other selection function of the XR device 902. In other examples, the controller 900 may be used to control or implement a desired action in a game or other application being executed by the XR device in the context of the user interface 916.

Further in various such contexts, multiple types of data may be transmitted between the controller 900 and the XR device 902. For example, in some implementations, the connection 901 may include a WiFi or Bluetooth connection. In other implementations, the UWB sensors 906, 908 may be used to implement the connection 901 for data communications, using UWB data packets that may also be used for determining a range and angle (and thus a position and orientation) of the controller 900.

For example, the UWB sensors 906, 908 may represent multiple transmitters/receivers used to establish a sufficient number of instances of the connection 901 to transmit all data needed for implementation of the user interface 916. For example, such data may include user selections or other inputs transmitted from the controller 900 to the XR device 902, or may include outputs from the XR device 902 to the controller 900, such as outputs for providing haptic feedback to the user 904. By integrating data communications with position/orientation determinations in the context of the UWB sensors 906, 908, the system of FIG. 9A provides high-speed, low-latency, high-bandwidth, and low-power data communications between the XR device 902 and the controller 900.

Thus, the techniques of FIG. 9A provide precise, consistent controller positioning for support of the XR device 902. As the controller 900 enables human interaction with the XR device 902, an accuracy of the motion tracking of the controller 900 is advantageously increased over conventional XR device controllers and provides an improved input experience for the user 904.

FIG. 9B is a block diagram of an example implementation of the system of FIG. 9A. In the example of FIG. 9B, the controller 900/900a is illustrated as controller 900b, while the XR device is illustrated as XR device 902b. The motion sensor 910 of FIG. 9A is illustrated as an IMU 910b. The UWB sensor 906 of the controller 900/900a of FIG. 9A is illustrated as a UWB receiver 906b.

Further with respect to the controller 900b of FIG. 9B, an LED array 918 is illustrated, which generally represents any suitable pattern of LEDs implemented at (e.g., coupled to) the controller 900b. For example, the LED array 918 may include a plurality of LEDs arranged in a known pattern and with respect to designated coordinates or positions on the controller 900b (e.g., top/bottom, and/or front/back).

A camera 920 may further be mounted on, or otherwise coupled to, the controller 900b. As described in detail, herein, both the LED array 918 and the camera 920 may be used to facilitate operations of the UWB receiver 906b and the IMU 910b in tracking a position and orientation of the controller 900b.

In the example of FIG. 9B, the controller 900b is illustrated as including a processor 922, e.g., a system on a chip (SoC). The processor 922 may be configured to execute an implementation of the controller tracking manager 914 of FIG. 9A, shown as controller tracking manager 914b in FIG. 9B. For example, the controller tracking manager 914b may be stored on, and loaded from, any suitable storage medium 924 (e.g., a non-transitory computer-readable storage medium).

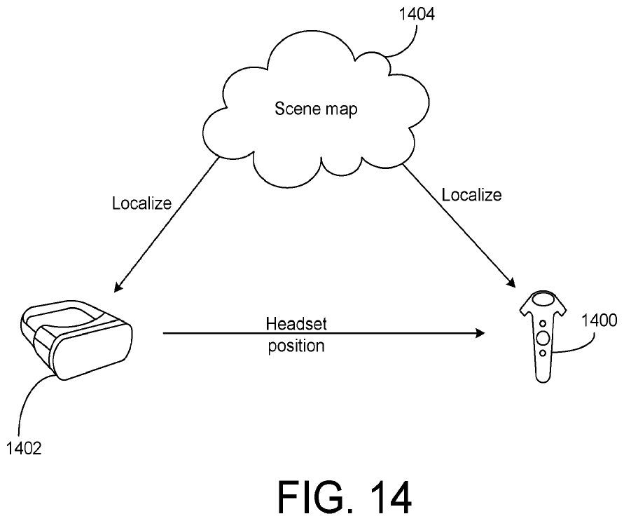

The controller tracking manager 914b is illustrated as including a calibration module 926, a state estimation module 928, and a signal quality computation module 930. The calibration module 926, described in more detail, below, with respect to FIG. 14, may be configured to initialize and otherwise calibrate tracking of the controller 900b. The state estimation module 928, described in more detail, below, with respect to FIGS. 8-13B, may be configured to track a position and orientation of the controller 900b. The signal quality computation module 930 may be configured to determine a reliability of, or confidence in, the state estimates of the state estimation module 928.

The XR device 902b may include a UWB transmitter 908b as an example or instance of the UWB sensor 908 of FIG. 9A. As referenced above, and shown in FIG. 9B, the UWB transmitter 908b may transmit UWB packet(s) 936 to the UWB receiver 906b of the controller 900b.

A headset pose generator 932 may be configured to track a current headset pose 940 of the XR device 902b with respect to a defined, real-world coordinate system.

Such headset pose generation may be performed, for example, for implementing functions of the XR device 902b, such as tracking a gaze direction of the user 904 of FIG. 9A.

A camera 934 may be configured to capture images of the controller 900b, e.g., of the LED array 918, to assist in tracking of the controller 900b. The camera 934 may also be used in conjunction with the headset pose generator 932. For example, the headset pose generator 932 may utilize images from the camera 934 of an environment of the user 904 to implement visual odometry (VO) or may utilize the images together with IMU data of one or more IMUs of the XR device (not shown in FIG. 9B), to implement visual inertial odometry (VIO), in order to facilitate generation of the headset pose 940.

Thus, in operation, the UWB transmitter 908b may transmit UWB packet(s) 936 to the controller 900b, for receipt using the UWB receiver 906b. The UWB receiver 906b may thus output range/angle measurements 938 for processing by the controller tracking manager 914b.

At the same time, IMU data 939 may be received at the controller tracking manager 914b from the IMU 910b. Thus, the state estimation module 928 may perform sensor fusion of the range/angle measurements 938 and the IMU data 939 to determine a current state of the controller 900b.

In some example implementations, the state estimation module 928 may supplement or augment such state calculations, using one or more other components of the system of FIG. 9B. For example, the state estimation module 928 may utilize the headset pose 940 to determine, or make use of, a common coordinate system for both the controller 900b and the XR device 902b. Accordingly, the determined state of the controller 900b may be defined with respect to, or in the context of, such a common coordinate system.

In other examples, the calibration module 926 may utilize the LED image 942 to perform an initialization or other calibration of the state of the controller 900b. For example, the calibration module 926 may utilize a known position of LEDs of the LED array 918 on a body of the controller 900b to recognize an initial position of the controller 900b at a start of state tracking.

In other examples, the camera 920 of the controller 900b may be used to facilitate calibration and/or state tracking operations. For example, the camera 920 may communicate with the camera 934 to define a common map of surroundings of the XR device 902b and the controller 900b, e.g., using the SLAM algorithm. In still other examples, the camera 920 may provide images that supplement or replace the IMU data 939 for purposes of state estimation operations of the state estimation module 928.

The UWB receiver 906b, the UWB transmitter 908b, and the IMU 910b all represent relatively low-cost, low-power devices, and the controller tracking manager 914b enables use of the range/angle measurements 938 and the IMU data 939 to provide fast, responsive, accurate state sensing in such low-cost, lower power contexts.

Other sensors, such as the camera 920 and the camera 934, may be capable of providing similar motion data, but may consume higher levels of power, may consume more memory/processing resources, or may have other potential drawbacks. Nonetheless, in example implementations, such sensors may be incorporated on an as-needed basis to supplement data of the range/angle measurements 938 and the IMU data 939, including replacing such data for at least limited time periods.

For example, as noted above, the signal quality computation module 930 may be configured to determine noise levels in data being processed by the state estimation module 928. For example, the range/angle measurements 938 may experience increases in noise levels as a range between the XR device and the controller 900b increases, or when an obstruction is positioned between the controller 900b and the XR device 902b.

When the signal quality computation module 930 detects such scenarios (e.g., relative noise levels), the signal quality computation module 930 may update a relative weight of the range/angle measurements 938 with respect to calculations of the state estimation module 928. For example, as a SNR of the range/angle measurements 938 changes, a relative weight of the range/angle measurements 938 in the calculations of the state estimation module 928 may be increased or decreased.

For example, a range threshold(s) may be set, beyond which range measurements may be downgraded. The range threshold(s) may vary based on other factors, such as a current position (e.g., front, back, or side) of the controller 900b with respect to the XR device 902b. For example, a range threshold when the controller 900b is behind the XR device 902b may be less than a range threshold when the controller 900b is in front of the XR device 902b.

Further, described techniques enable opportunistic use of relatively higher-power sensors, such as the cameras 920, 934. For example, when a signal to noise ratio (SNR) of the range/angle measurements 938 falls below a threshold value, the state estimation module 928 may temporarily utilize image data from one or both of the cameras 920, 934 to replace or augment the range/angle measurements 938.

FIG. 9C is a block diagram of another example implementation of the system of FIG. 9A. In the example of FIG. 9C, a controller 900c includes the UWB sensor 906 of FIG. 9A as UWB transmitter 906c, while the UWB sensor 908 of FIG. 9A is included as a UWB receiver 908c in FIG. 9C. In other words, in contrast to FIG. 9B, FIG. 9C includes the UWB transmitter 906c at the controller 900c, so that UWB packet(s) 936 are transmitted in a direction from the controller 900c to the UWB receiver 908c at the XR device 902c.

Then, similarly to the example of FIG. 9B, the UWB receiver 908c may output range/angle measurements 938, which may be fused at the controller tracking manager 914c with IMU data 939 from IMU 910c of the controller 900c. Although shown as being transmitted separately in FIG. 9C, it will be appreciated from the above description that the UWB packet 936 and the IMU data 939 may be transmitted using one or more communication channels between the UWB transmitter 906c and the UWB receiver 908c. For example, the IMU data 939 may be included in the same UWB packet 936, or in a different UWB packet, as part of the connection 901 (e.g., communications channel) of FIG. 9A.

Remaining portions of FIG. 9C are similar to corresponding portions of FIG. 9B, and are numbered using the same reference numerals, although the processor 922 and the storage medium 924 are implemented at the XR device 902c rather than at the controller 900c. In more detail, and as shown, the controller tracking manager 914c receives the range/angle measurements 938 and the IMU data 939 and the state estimation module 928 calculates a current state of the controller 900c, as described in more detail, below, with respect to FIGS. 8-13B. As described there, and as referenced above, the state estimation module 928 may utilize the headset pose 940 and associated coordinate frame to define a current state of the controller 900c with respect to a coordinate frame being used for the XR device 902c.

As also referenced above, and described in more detail, below, with respect to FIG. 14, the calibration module 926 may be configured to utilize the LED images 942 from the camera 934 of the LED array 918 to perform an initialization or other calibration of a state of the controller 900c. The signal quality computation module 930 may be configured to quantify a current reliability or confidence level of the range/angle measurements 938, and thus of the estimate state of the controller 900c. When the determined reliability/confidence level is low, the state estimation module 928 may make use of image data from the camera 934 of the XR device 902c (e.g., the LED images 942) and/or image data from the camera 920 of the controller 900c to supplement, augment, or replace the range/angle measurements 938.

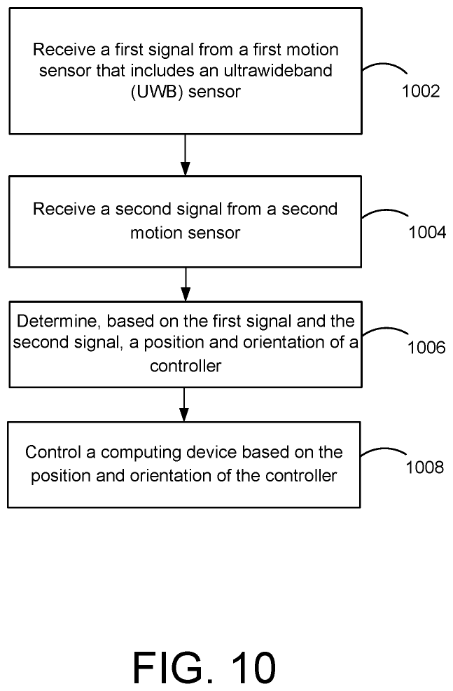

FIG. 10 is a flowchart illustrating example operations of the systems of FIGS. 9A-9C. In the example of FIG. 10, illustrated operations are shown as separate, sequential operations. In example implementations, additional and/or alternative operations or suboperations may be included, and/or one or more operations may be omitted. In all such implementations, the various operations and/or suboperations may be implemented in a partially or completely overlapped or parallel manner, or in an iterative, nested, looped, or branched fashion. FIG. 10 can be seen as relating to a method of controller tracking.

In the example of FIG. 10, a first signal may be received from a first motion sensor that includes an ultrawideband (UWB) sensor (1002). For example, the first signal may include the UWB packet(s) 936 of FIGS. 9B and 9C, and may be received at the state estimation module 928. The first signal may include a single or a plurality of measurements from one or more UWB sensors.

A second signal may be received from a second motion sensor (1004). For example, the IMU data 939 may be received at the state estimation module 928. In other examples, image data from the camera 920 and/or the camera 934 may be received as the second signal. In other examples, the second signal may be received from additional UWB motion sensors. As with the first signal, the second signal may include a single or a plurality of measurements from one or more UWB sensors. The first and the second motion sensor can be located at the same location or at different locations in or on the controller. Also, the first and the second motion sensor can be of the same type or different types.

Based on the first signal and the second signal, a position and orientation of a controller may be determined (1006). For example, the state estimation module 928 may determine a position and orientation of the controller 900b of FIG. 9B or the controller 900c of FIG. 9C. For example, the position and orientation may be determined with respect to a coordinate frame determined from, or in conjunction with, the headset pose 940.

A computing device may be controlled, based on the position and orientation of the controller (1008). For example, the XR device 902b of FIG. 9B or the XR device 902c of FIG. 9C may be controlled.

FIGS. 9A-9C and FIG. 10 thus illustrate that UWB sensors may be used on a controller as well as a headset (or other XR device). One or more (e.g., a plurality of) UWB antennas may be used, with multiple antennas providing additional accuracy and/or greater coverage of obtained measurements. One or more IMUs may be used on the controller to measure controller motion at a high rate, where multiple IMUs may be used to obtain better accuracy or to help calibrate the system.

As also shown and described, one or more LEDs (e.g., infrared (IR) LEDs) may be used, including a small number of LEDs in a compact configuration. One or more cameras may be leveraged to assist with motion tracking, including using such camera(s) opportunistically, as needed to ensure accuracy while minimizing use of available power.

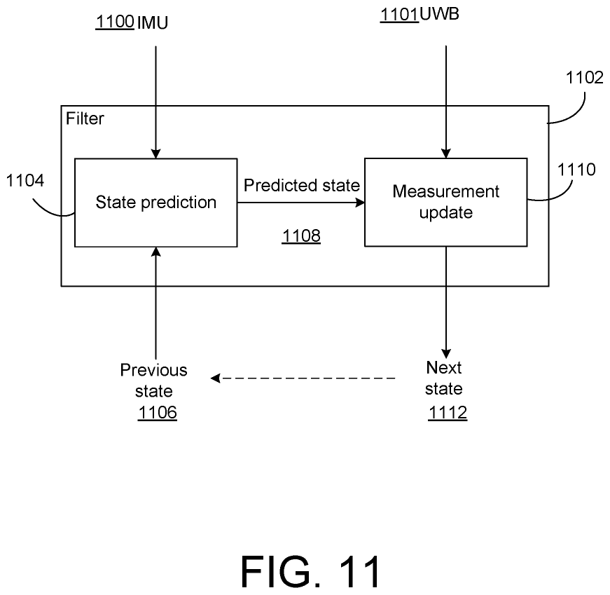

FIG. 11 is a block diagram of a state estimation module that may be used in the examples of the systems of FIGS. 9A-9C. In the example of FIG. 11, a filter 1102, e.g., a Kalman filter, e.g., an extended Kalman filter (EKF), is illustrated that may represent an example of a filter that may be used in the state estimation module 928 of FIGS. 9B and 9C. However, as referenced above, various modifications of the filter 1102 may be used in the different example embodiments described herein, or in other embodiments.

In the example of FIG. 11, a state prediction 1104 for a XR controller, such as the controller 900 of FIG. 9A, may be generated based on motion data from an IMU 1100 and on a previous state 1106, to thereby obtain a predicted state 1108. A measurement from a UWB receiver 1101 may then be used with the predicted state 1108 to determine a measurement update 1110. The measurement update 1110 thus provides a next state 1112.

For example, conceptually, the next state 1112 may be determined to have a value that is between a measured state (not shown separately or explicitly in FIG. 11) determined by the UWB receiver 1101 and the predicted state 1108. Weight(s) given to each of the measured state and the predicted state 1108 may be determined by various factors, such as an amount of bias or noise present in a given input(s) from the IMU 1100.

As shown in FIG. 11, this processing may continue recursively and iteratively to continuously determine state information regarding the controller 900. As referenced above, the filter 1102 of FIG. 11 may also incorporate motion data from one or more of the cameras 934, 920, and/or from additional IMUs and/or UWB receivers.

Thus, as illustrated by FIG. 11, described tracking algorithms may be implemented via a state estimation framework that estimates in real-time a 6 degree of freedom (6DoF) pose of a controller with respect to a coordinate frame. For example, as noted above, an EKF may be used in the context of the example of FIG. 11 to estimate the state.

For example, the state prediction may be implemented using a state prediction model that uses IMU integration of IMU measurements to predict the state. The predicted state may be corrected by using range and angle measurements from a UWB sensor. Images from a headset observing IR LEDs on a controller, and/or feature measurements from camera(s) on the controller, may be used as additional measurement constraints.

As described with respect to FIGS. 9B and 9C, execution of the tracking algorithm using state estimation as shown in FIG. 11 may be implemented either at a controller or at a headset. In implementations in which the tracking algorithm runs on a controller, the controller may be configured as the receiver (RX). A measured range may be determined with respect to the headset (transmitter), so that the controller may receive the position and orientation of the headset with respect to a fixed world frame and estimate its own pose in the world frame. For example, the controller may receive a measurement of range and Angle of Arrival (AoA) with respect to the headset, along with a stream of the headset pose with respect to a world frame. Then, the controller may use the received information in conjunction with local IMU data to track the controller pose in the world.

In another implementation, in which the tracking algorithm runs on a headset, the headset may use a calculated headset pose, UWB range measurement (between headset and controller) and controller IMU data (streamed to headset) in order to estimate the controller pose. In these examples, a motion tracking module on the headset may receive a measurement of range & AoA, and may then fuse this sensor data with sensor data received from a controller IMU to compute a pose(s) of the controller.

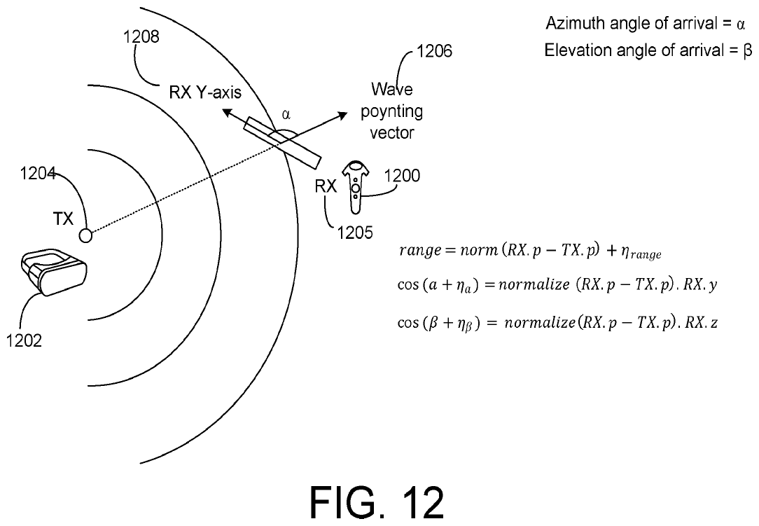

FIG. 12 illustrates an example system for range and angle determination using UWB sensors for use in the state estimation module of FIG. 11. That is, FIG. 12 illustrates a measurement model for range and angle measurements determined using UWB sensors, which may be used to provide the measurement update 1110 of FIG. 11.

In more detail, in the example of the techniques for XR controller motion tracking using a state estimation approach based on an EKF, the state captures variables that govern an evolution of the controller motion, as well as various sensor calibration parameters that are necessary for physical modeling of the sensor measurements.

In one example implementation, the state may include: a position [x,y,z] of the controller in a world frame (in meters), an orientation of the controller in a world frame as a quaternion [w,x,y,z], a velocity [u_x, u_y, u_z] of the controller in a world frame (in meters/sec), and one or more variables modeling the UWB sensor calibration (e.g., sensor bias or signal strength values).

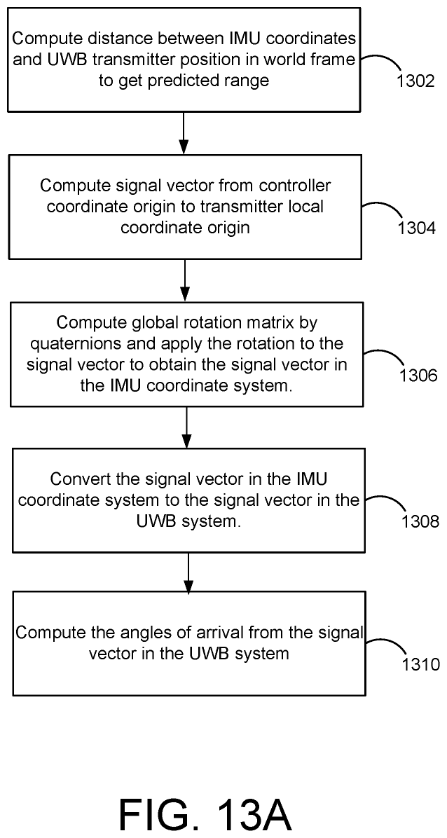

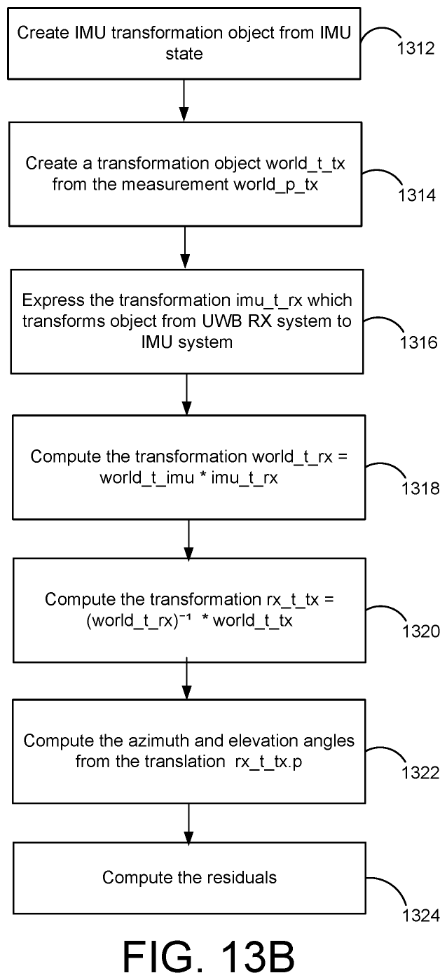

The evolution of the state may then be governed by the type of state prediction equation referenced above (and described in more detail, below, with respect to FIG. 13A), which specifies calculations for the predicted state at a future timestamp, given the current state estimate. The state prediction equation may be designed to model the physical constraints of the system along with uncertainties in the prediction as specified by the state prediction noise. In some examples, the IMU measurements are an input to the state prediction equation, also referred to as the state evolution equation, and may thus be used to assist the prediction of the state to a future timestamp.

Then, a UWB measurement model, as illustrated in FIG. 12 (also referred to as an observation model), may be used to correct the state based on a measurement update, once the future timestamp has been reached. Specifically, FIG. 12 illustrates an example with a controller 1200 and a headset 1202. The headset 1202 includes a UWB transmitter 1204, which sends UWB packets to a UWB receiver 1205.

In FIG. 12, a y-axis 1208 of the UWB receiver 1205 is illustrated separately to demonstrate an azimuth angle of arrival a, define relative to a wave poynting vector 1206 of the received UWB data packets. An elevation angle of arrival β, along with a range or distance between the UWB transmitter 1204 and the UWB receiver 1205, may be determined using Equations (1)-(3):

$$range = norm ( RX . p - TX . p ) + {η}_{range} \qquad Equation ( 1 )$$

$$cos ( a + {η}_{a} ) = normalize ( RX . p = TX . p ) . RX . y \qquad Equation ( 2 )$$

$$cos ( β + {η}_{β} ) = normalize ( RX . p = TX . p ) . RX . z \qquad Equation ( 3 )$$

Described procedures may be easily extended to the case of UWB measurements from multiple antennas on a controller. Procedures may also be extended to include both the case of angle measurements at the receiver (angle of arrival) as well as at the transmitter (angle of departure).

FIG. 13A is a flowchart illustrating example calculations for predicting range and angle measurements using an inertial measurement unit (IMU) for use in the state estimation module of FIG. 11. Herein, the term “predicting” can be replaced with “determining” That is, FIG. 13A illustrates techniques for calculating predicted measurements for state prediction 1104 in FIG. 11, using the obtained state vector of the measurement model of FIG. 12. Put another way, FIG. 13A illustrates predicted estimates of the state vector for a measurement time stamp, which may then be used to compute further predicted measurements.

In FIG. 13A, an IMU state for a current frame is defined as referenced above, with IMU_state=[a, b, c, w, x, y, z], where [a, b, c] defines coordinates of the IMU in the global/world system, and [w, x, y, z] defines the quaternions. Then, a distance between the [a, b, c] coordinates and the UWB transmitter position in the world may be calculated to obtain a predicted range in meters (1302).

A vector v_gobal from the controller coordinate origin to the transmitter local coordinate origin may then be computed (1304). This vector represents the signal and is referred to as the signal vector.

A global rotation matrix by quaternions may be computed and the rotation may be applied to the signal vector v_gobal to obtain the signal vector in the IMU coordinate system (1306), referred to as v_imu. Then, v_imu may be converted to the v_uwb (1308), which represents the signal vector in the UWB system.

Finally in FIG. 13A, angles of arrival may be computed from the signal vector in the UWB system v_uwb (1310). For example, the elevation angle of arrival may be computed as −a sin(v_uwb(2)/v_uwb.norm( )), and the azimuth angle of arrival may be computed as a tan 2(v_prime(1), v_prime(0)), where the azimuth angle of arrival may be converted from [−pi, pi] to [−pi/2, pi/2].

FIG. 13B is a flowchart illustrating example calculations for determining a residual function used to determine a difference between the range and angle determination of FIG. 12 and the range and angle prediction of FIG. 13A, for use in the state estimation module of FIG. 11. The difference(s) between these predicted measurements and actual measurements, are referred to as a measurement residual function, which may be used to update the state estimate using EKF measurement update equations.

More specifically, a residual function of a UWB range measurement constraint is a function that represents the difference between the actual range measurements and the predicted range measurement. The residual function may thus be used to evaluate the accuracy of the range measurements.

In FIG. 13B, a measurement is encoded as: [range_m, azimuth_deg, elevation_deg, world_p_tx_x, world_p_tx_y, world_p_tx_z]. UWB measurements may be expressed as: [range (in meter), azimuth ([−pi/2, pi/2]), elevation ([−pi/2, pi/2] radians)]. For the measurement of the residual, the UWB coordinates of the transmitter (TX) in the world system may be added, because the UWB measurement is relative to the UWB TX.

To compute the residuals, a transformation object world_t_imu may be created from the IMU state imu_state (1312). A transformation object world_t_tx may be created from the measurement (world_p_tx) (1314).

The transformation imu_t_rx may be expressed, which transforms the object from UWB RX system to IMU system (1316). Then, the transformation world_t_rx=world_t_imu*imu_t_rx, which transforms the object from UWB RX system to world system, may be computed (1318). The transformation rx_t_tx−(world_t_rx)⁻¹*world_t_tx may also be computed (1320).

The azimuth and elevation angles may then be computed from the translation rx_t_tx.p (1322), e.g., az_aoa_est_deg=a tan 2(rx_t_tx.p( )(1), rx_t_tx.p( )(0)), el_aoa_est_deg=−a sin(rx__tx.p( )(2)/rx__tx.p.norm ( ))) (where the azimuth angle may be converted from [−pi, pi] to [−pi/2, pi/2]).

Finally in FIG. 13B, the residuals may be computed (1324) as: residual[0]=range_m−rx_t_tx.p.norm( )+noise[0], residual[1]=azimuth_deg−estimated_azimuth_deg+noise[1], and residual[2]=elevation_deg−estimated_elevation_deg+noise[2]

FIG. 14 is a block diagram illustrating an example initialization procedure for use in the examples of FIGS. 9A-9C. As referenced above, the tracking techniques described with respect to FIGS. 9A-11 may include initialization of an initial state, prior to accurate and reliable use of, e.g., the system of FIG. 11, to update a tracked state of a controller.

In the example implementation of FIG. 14, a system design may be used that involves one or more cameras on a controller 1400. Then, example implementations may involve exchanging a scene map 1404 from a headset 1402 to the controller 1400. The controller 1400 may then use the scene map to localize itself within the scene map 1404, using images from the camera(s).

In another example implementation(s), one or more IR LED(s) may be used on the controller 1400. Then, a low-exposure image may be captured using a camera of the headset 1402. The detected LED(s) may then be used to compute an initial pose of the controller 1400 with respect to the headset 1402.

In an example implementation with a UWB sensor and IMU on the controller 1400, the IMU may be used to detect the gravity direction (e.g., gravity-aligned orientation in 3DoF rotation) to initialize the controller pose. Subsequently, a calibration procedure with a recommended motion pattern may be used in order to initialize the position and rotation of the controller 1400 around the direction of gravity.

Yet another example implementation involves using an image of the controller 1400. For example, a camera of the headset 1402 may be used to perform image-based pose estimation of the controller 1400 for system initialization in a shared coordinate frame.

Various combinations and additional implementations may be used, as well. For example, a batch of measurements of headset poses (in world frame), LED detections, and/or controller poses with respect to a headset frame may be used with IMU measurements from the controller 1400 to solve for the controller pose initialization.

In addition to initialization and calibration, described techniques may include or utilize one or more noise models. As already referenced, it may be advantageous to account for times and situations in which noise levels increase relative to signal strength(s), in order to gauge a current reliability of current state estimation calculations.

For example, to correctly weigh UWB measurements in the EKF filter update of the example of FIG. 11, noise in the measurements may be modeled to define a confidence level in the measurements. For example, accuracy levels of measurements from a UWB sensor in a controller may vary depending on whether the UWB sensor is in front of, behind, or to a side of, a headset with a corresponding UWB sensor.

In an example implementation, UWB measurement noise may be modeled by setting a standard deviation of noise based on the range and AoA that are detected. For example, if the controller is at the back of the transmitter device and the measured range is within 1 meter, the error level of the measurement may be set to be lower than if the controller device is in the front or sides, and/or if the range is longer. Accordingly, the varying confidence level(s) of the measurements at the various positions may be accurately reflected.

In another example implementation, a received signal strength (RSS) of the wireless signal at the receiver (e.g., controller) may be used to modulate the noise level of the measurements. In these implementations, the noise modulation algorithm may be used to compensate for the variations in RSS across different settings/antennas, e.g., to mitigate the variation in the noise level due to inherent temporal variations in RSS (such as 3 db), even with respect to the same device(s) in the same location.

As described above, example techniques include use of one or more IMUs to measure controller motion at high frequency, while using UWB sensors to limit the IMU drift. As described, IMUs often provide good short-term accuracy but are subject to cumulative errors over time. UWB sensors, meanwhile, provide range and angle measurements that do not drift with time, and can be used to account for the IMU drift. Combining IMUs with UWBs for controller control using sensor fusion provides cost advantages over camera-based designs, while being complementary to IR LED array based systems.

Thus, described techniques provide precise tracking of a position and orientation of a controller relative to a XR headset. For example, described techniques include a recursive filtering or state estimation method that does detailed physical modeling to represent the system state, and physical modeling of the sensor measurements to obtain measurement equations for state update.

Described techniques generalize to arbitrary motion patterns depending on the XR use-case. Unlike a ML-based solution, described techniques generalize to any motion pattern by design, and do not require training to recognize specific motion patterns.

Described techniques enables full utilization of sensor capabilities of UWB sensors, including use of Angle of Arrival (AoA) (azimuth and elevation angles of the receiver with respect to the wave poynting vector from the transmitter) and of Angle of Departure (AoD) (azimuth and elevation angles of the transmitter with respect to the wave poynting vector to the receiver).

Described techniques thus enable high-rate sensor fusion in a limited compute budget, enabling responsiveness to fast motions, with low latency and low power. Described techniques do not rely on the presence of cameras or depth cameras on either the headset or controller. Solutions are cross-compatible with different headsets having UWB sensors.

Moreover, described techniques may be easily extended to the case of multiple IMUs or UWB sensors on the controller or headset. Additionally, described techniques enable modeling of calibration parameters as part of the state, thereby enabling online calibration and high accuracy motion tracking. Unlike an ML-based solution, described techniques do not degrade due to sensor calibration issues with usage. Described techniques leverage the UWB as a range and angle sensor as well as a low-latency communications channel to support low latency real time sensor fusion for controller tracking.

In Example 1, a method includes:
receiving a first signal from a first motion sensor that includes an ultrawideband (UWB) sensor;
receiving a second signal from a second motion sensor;
determining, based on the first signal and the second signal, a position and orientation of a controller; and
controlling a computing device based on the position and orientation of the controller.

Example 2 includes the method of Example 1, further comprising:
predicting a future position and orientation of the controller at a first timestamp, using the second signal;
measuring an actual position and orientation of the controller upon reaching the first timestamp, using the first signal;
determining a residual difference between the future position and the actual position; and
predicting a second future position and orientation of the controller at a second timestamp, based on the residual difference.

Example 3 includes the method of Example 1, further comprising:
performing sensor fusion of the first signal and the second signal to determine the position and orientation of the controller.

Example 4 includes the method of Example 1, further comprising:
receiving the second signal from the second motion sensor that includes an Inertial measurement unit (IMU) coupled to the controller.

Example 5 includes the method of Example 1, further comprising:
receiving the first signal from the first motion sensor that includes a UWB receiver coupled to the computing device and a UWB transmitter coupled to the controller.

Example 6 includes the method of Example 1, further comprising:
receiving the first signal from the first motion sensor that includes a UWB receiver coupled to the controller and a UWB transmitter coupled to the computing device.

Example 7 includes the method of Example 1, further comprising:
transmitting the first signal and the second signal between the controller and the computing device, using UWB packets of the UWB sensor.

Example 8 includes the method of Example 1, wherein the computing device includes an extended reality (XR) headset.

Example 9 includes the method of Example 8, further comprising:
determining the position and orientation of the controller with respect to a headset pose of the XR headset.

Example 10 includes the method of Example 8, further comprising:
constructing, using one or more cameras coupled to the XR headset or the controller, a scene map;
localizing, using one or more images from the one or more cameras, the controller within the scene map; and
initializing the position and orientation of the controller within the scene map, based on the localizing.

Example 11 includes a computer program product, the computer program product being tangibly embodied on a non-transitory computer-readable storage medium and comprising instructions that, when executed by at least one computing device, are configured to cause the at least one computing device to:
receive a first signal from a first motion sensor that includes an ultrawideband (UWB) sensor;
receive a second signal from a second motion sensor;
determine, based on the first signal and the second signal, a position and orientation of a controller; and
control a computing device based on the position and orientation of the controller.

Example 12 includes the computer program product of Example 11, wherein the instructions, when executed by the at least one computing device, are further configured to cause the at least one computing device to:
predict a future position and orientation of the controller at a first timestamp, using the second signal;
measure an actual position and orientation of the controller upon reaching the first timestamp, using the first signal;
determine a residual difference between the future position and the actual position; and
predict a second future position and orientation of the controller at a second timestamp, based on the residual difference.

Example 13 includes the computer program product of Example 11, wherein the instructions, when executed by the at least one computing device, are further configured to cause the at least one computing device to:
perform sensor fusion of the first signal and the second signal to determine the position and orientation of the controller.

Example 14 includes the computer program product of Example 11, wherein the instructions, when executed by the at least one computing device, arc further configured to cause the at least one computing device to:
receive the second signal from the second motion sensor that includes an Inertial measurement unit (IMU) coupled to the controller.

Example 15 includes the computer program product of Example 11, wherein the instructions, when executed by the at least one computing device, are further configured to cause the at least one computing device to:
receive the first signal from the first motion sensor that includes a UWB receiver coupled to the computing device and a UWB transmitter coupled to the controller.

Example 16 includes the computer program product of Example 11, wherein the instructions, when executed by the at least one computing device, are further configured to cause the at least one computing device to:
receive the first signal from the first motion sensor that includes a UWB receiver coupled to the controller and a UWB transmitter coupled to the computing device.

Example 17 includes a device comprising:
a first motion sensor that includes an ultrawideband (UWB) sensor;
at least one processor;
at least one memory, the at least one memory storing a set of instructions, which, when executed, cause the at least one processor to:
   receive a first signal from the first motion sensor;
   receive a second signal from a second motion sensor;
   determine, based on the first signal and the second signal, a position and orientation of a controller; and
   provide control of an extended reality (XR) headset based on the position and orientation of the controller.

Example 18 includes the device of Example 17, wherein the set of instructions, when executed by the at least one processor, are further configured to cause the device to:
predict a future position and orientation of the controller at a first timestamp, using the second signal;
measure an actual position and orientation of the controller upon reaching the first timestamp, using the first signal;
determine a residual difference between the future position and the actual position; and
predict a second future position and orientation of the controller at a second timestamp, based on the residual difference.

Example 19 includes the device of Example 17, wherein the device includes the controller, the second motion sensor includes an inertial measurement unit (IMU) coupled to the controller, and the first motion sensor includes a UWB transmitter coupled to the controller, with a UWB receiver coupled to the XR headset.

Example 20 includes the device of Example 17, wherein the device includes the XR headset, the second motion sensor includes an inertial measurement unit (IMU) coupled to the controller, and the first motion sensor includes a UWB receiver coupled to the controller, with a UWB transmitter coupled to the XR headset.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the description and claims.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for case of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example implementations.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A method comprising:
receiving a first sensor signal from a first sensor coupled to an extended reality device within a moving frame of reference;
receiving a second sensor signal from an image sensor within the moving frame of reference and in communication with the extended reality device; and
determining a motion of the extended reality device with respect to the moving frame of reference, based on the first sensor signal and the second sensor signal.

2. The method of claim 1, wherein the extended reality device and the image sensor are located within a vehicle that defines the moving frame of reference, the first sensor includes an inertial measurement unit (IMU) and a camera, and further wherein determining the motion of the extended reality device with respect to the moving frame of reference comprises:
removing motion due to the moving frame of reference, as determined using the second sensor signal, from aggregate motion due to the moving frame of reference of vehicle motion of the vehicle and from motion of the extended reality device, as determined from the first sensor signal using visual inertial odometry.

3. The method of claim 1, wherein the extended reality device and the image sensor are located within a vehicle that defines the moving frame of reference.

4. The method of claim 1, wherein the extended reality device and the image sensor are located within a vehicle that defines the moving frame of reference, and further wherein the image sensor is coupled to a device that is mounted to a frame of the vehicle.

5. The method of claim 4, wherein the image sensor is included in a front-facing camera of the device that is directed to capture an interior of the vehicle.

6. The method of claim 4, wherein the image sensor is included in a camera of the device that is directed to capture an exterior environment of the vehicle.

7. The method of claim 6, further comprising:
capturing an image of the exterior environment using the image sensor; and
generating a user interface of the extended reality device that uses the image to provide an inertial frame of reference within a view of the extended reality device.

8. The method of claim 1, wherein the extended reality device and the image sensor are located within a vehicle that defines the moving frame of reference, and further wherein the image sensor is coupled to a second extended reality device within the vehicle.

9. The method of claim 8, further comprising:
generating a map of an interior of the vehicle, using the image sensor and a camera of the extended reality device.

10. The method of claim 1, comprising:
receiving the second sensor signal from a second extended reality device within the moving frame of reference.

11. A computer program product, the computer program product being tangibly embodied on a non-transitory computer-readable storage medium and comprising instructions that, when executed by at least one computing device, are configured to cause the at least one computing device to:
receive a first sensor signal from a first sensor coupled to an extended reality device within a moving frame of reference;
receive a second sensor signal from an image sensor within the moving frame of reference and in communication with the extended reality device; and
determine a motion of the extended reality device with respect to the moving frame of reference, based on the first sensor signal and the second sensor signal.

12. The computer program product of claim 11, wherein the image sensor is coupled to a device that is mounted to a frame of a vehicle that defines the moving frame of reference.

13. The computer program product of claim 12, wherein the image sensor is included in a front-facing camera of the device that is directed to capture an interior of the vehicle.

14. The computer program product of claim 12, wherein the image sensor is included in a camera of the device that is directed to capture an exterior environment of the vehicle.

15. The computer program product of claim 14, wherein the instructions, when executed by the at least one computing device, are further configured to cause the at least one computing device to:
capture an image of the exterior environment using the image sensor; and
generate a user interface of the extended reality device that uses the image to provide an inertial frame of reference within a view of the extended reality device.

16. The computer program product of claim 11, wherein the image sensor is coupled to a second extended reality device within a vehicle that defines the moving frame of reference.

17. A system comprising:
at least one frame for positioning a head mounted device (HMD) on a face of a user;
at least one camera;
at least one motion sensor;
at least one processor; and
at least one memory, the at least one memory storing a set of instructions, which, when executed, cause the at least one processor to:
receive a first sensor signal from the at least one camera and the at least one motion sensor within a moving frame of reference;
receive a second sensor signal from an image sensor within the moving frame of reference and in communication with the HMD; and
determine a motion of the HMD with respect to the moving frame of reference, based on the first sensor signal and the second sensor signal.

18. The system of claim 17, wherein the image sensor is coupled to a device that is mounted to a frame of a vehicle that defines the moving frame of reference.

19. The system of claim 17, wherein the image sensor is included in a camera of the HMD that is directed to capture an exterior environment of a vehicle that defines the moving frame of reference.

20. The system of claim 17, wherein the image sensor is coupled to a second extended reality device within a vehicle that defines the moving frame of reference.

21. A method comprising:
receiving a first signal from a first motion sensor that includes an ultrawideband (UWB) sensor;
receiving a second signal from a second motion sensor;
determining, based on the first signal and the second signal, a position and orientation of a controller; and
controlling a computing device based on the position and orientation of the controller.

22. The method of claim 21, further comprising:
predicting a future position and orientation of the controller at a first timestamp, using the second signal;
measuring an actual position and orientation of the controller upon reaching the first timestamp, using the first signal;
determining a residual difference between the future position and the actual position; and
predicting a second future position and orientation of the controller at a second timestamp, based on the residual difference.

23. The method of claim 21, further comprising:
performing sensor fusion of the first signal and the second signal to determine the position and orientation of the controller.

24. The method of claim 21, further comprising:
receiving the second signal from the second motion sensor that includes an Inertial measurement unit (IMU) coupled to the controller.

25. The method of claim 21, further comprising:
receiving the first signal from the first motion sensor that includes a UWB receiver coupled to the computing device and a UWB transmitter coupled to the controller.

26. The method of claim 21, further comprising:
receiving the first signal from the first motion sensor that includes a UWB receiver coupled to the controller and a UWB transmitter coupled to the computing device.

27. The method of claim 21, wherein the computing device includes an extended reality (XR) headset, and further comprising:
determining the position and orientation of the controller with respect to a headset pose of the XR headset.

28. The method of claim 27, further comprising:
constructing, using one or more cameras coupled to the XR headset or the controller, a scene map;
localizing, using one or more images from the one or more cameras, the controller within the scene map; and
initializing the position and orientation of the controller within the scene map, based on the localizing.
